(19) United States
(12) Patent Application Publication
(10) Pub. No.: US 2004/0256873 A1
(43) Pub. Date: Dec. 23, 2004

(54) Apparatus for configuring the cargo area of a vehicle

(76) Inventors: Patrick W. McManus, Bloomington, IN (US); Martin P. McManus, Mishawaka, IN (US)

Correspondence Address: BOSE MCKINNEY & EVANS LLP, 135 N PENNSYLVANIA ST, SUITE 2700, INDIANAPOLIS, IN, 46204, US

(21) Appl. No.: 10/815,596

(22) Filed: Apr. 1, 2004

Related U.S. Application Data
(60) Provisional application No. 60/476,257, filed on Jun. 5, 2003.

(51) Int. Cl. B62D 25/00

(52) U.S. Cl. 296/26.01

(57) ABSTRACT

An apparatus for configuring the cargo area of a vehicle includes an expansion portion or movable cover for increasing and decreasing the cargo area upon movement between a retracted position and an extended position.

### CROSS-REFERENCE TO RELATED APPLICATION

This application claims benefit of U.S. Provisional Application Ser. No. 60/476,257, filed Jun. 5, 2003, titled Apparatus for Configuring the Cargo Area of a Vehicle, the disclosure of which is expressly incorporated by reference herein.

### FIELD OF THE INVENTION

The present invention generally relates to an apparatus for configuring the cargo area of a vehicle, and more particularly to an expansion portion or adjustable cover that moves between a retracted position and an extended position to decrease and increase the cargo area, respectively.

### BACKGROUND OF THE INVENTION

Vehicle having cargo areas are used to haul items of a variety of different sizes. In some circumstances, it is desirable to have a cargo area of a relatively small size for carrying small items, while in other circumstances it is desirable to have a cargo area of a relatively large size for carrying large items. Conventional vehicles, such as pickup trucks, provide a fixed cargo area. Thus, consumers must choose a vehicle with a cargo area that will accommodate most cargo carrying situations, but which will be unsuited for other situations.

Moreover, users of such vehicle often desire a covered cargo area for hauling certain types of loads. Typically, a conventional pickup truck cap is attached to the bed of the vehicle to protect the contents of the cargo area. In some circumstances, however, the cap is unnecessary and/or an impediment to loading and unloading cargo into and out of the cargo area. Thus, the cap must be removed and stored for these hauling situations, then re-attached when the user desires a covered cargo area.

### SUMMARY OF THE INVENTION

The present invention provides an expansion portion for connection to the cargo area of a vehicle which permits the user to move the expansion portion between a retracted position, wherein a relatively small cargo area is provided, and an extended position, wherein a relatively large cargo area is provided. Additionally, the present invention provides several embodiments of an adjustable cover for the cargo area of a vehicle. Depending upon the embodiment, the cover may raised and lowered to increase and decrease the vertical dimension of the cargo area, or collapsed to provide an uncovered cargo area and extended to provide covered cargo area. In other embodiments, the present invention provides movable side walls of a cargo area to either increase and decrease the lateral dimension of the cargo area, or facilitate side loading and unloading into and out of the cargo area.

The features and advantages of the present invention described above, as well as additional features and advantages, will be readily apparent to those skilled in the art upon reference to the following description and the accompanying drawings.

### BRIEF DESCRIPTION OF THE DRAWINGS

FIG. 1 is a side elevational view of a vehicle having an expansion portion according to the present invention.

FIG. 2 is a side elevational view of the vehicle of FIG. 1 with the expansion portion in an extended position.

FIG. 3 is a side elevational view of a vehicle having two expansion portions according to the present invention.

FIG. 4 is a side plan view of the vehicle of FIG. 3 with both expansion portions in an extended position.

FIG. 5 is a perspective view of a vehicle having another embodiment of an expansion portion according to the present invention.

FIG. 6 is a perspective view of the vehicle of FIG. 5 with the expansion portion in an extended position.

FIG. 7 is a perspective view of a vehicle having another embodiment of an expansion portion according to the present invention.

FIG. 8 is a perspective view of the vehicle of FIG. 7 with the expansion portion in an extended position.

FIG. 9 is a perspective view of a vehicle having an adjustable cover according to the present invention.

FIG. 10 is a perspective view of the vehicle of FIG. 9 with the adjustable cover in an extended position.

FIG. 11 is a perspective view of a vehicle having another embodiment of an adjustable cover according to the present invention.

FIG. 12 is a perspective view of the vehicle of FIG. 11 with the adjustable cover in an extended position.

FIG. 13 is a perspective view of a vehicle having another embodiment of an adjustable cover according to the present invention.

FIG. 14 is a perspective view of the vehicle of FIG. 13 with the adjustable cover in an extended position.

FIG. 15 is a perspective view of a vehicle having another embodiment of an adjustable cover according to the present invention.

FIG. 16 is a perspective view of the vehicle of FIG. 15 with the adjustable cover in an extended position.

FIG. 17 is a perspective view of a vehicle having another embodiment of an adjustable cover according to the present invention.

FIG. 18 is a perspective view of the vehicle of FIG. 17 with the adjustable cover in an extended position.

FIG. 19 is a perspective view of a vehicle having another embodiment of an adjustable cover according to the present invention.

FIG. 20 is a perspective view of the vehicle of FIG. 19 with the adjustable cover in an extended position.

FIG. 21 is a perspective view of a vehicle having another embodiment of an adjustable cover according to the present invention.

FIG. 22 is a perspective view of the vehicle of FIG. 21 with the adjustable cover in an intermediate position.

FIG. 23 is a perspective view of the vehicle of FIG. 21 with the adjustable cover in an extended position.

FIG. 24 is a perspective view of a vehicle having another embodiment of an adjustable cover according to the present invention.

FIG. 25 is a perspective view of the vehicle of FIG. 24 with the adjustable cover in an extended position.

FIG. 26 is a perspective view of a vehicle having an apparatus for configuring a cargo area according to the present invention.

FIG. 27 is a perspective view of the vehicle of FIG. 26 with the apparatus in an extended position.

FIG. 28 is a perspective view of a vehicle having an apparatus for configuring a cargo area according to the present invention.

FIG. 29 is a perspective view of the vehicle of FIG. 28 with the apparatus in an extended position.

FIG. 30 is a perspective view of a vehicle having a movable floor portion according to the present invention.

FIG. 31 is a perspective view of the vehicle of FIG. 30 with the floor portion in an intermediate position.

FIG. 32 is a perspective view of the vehicle of FIG. 30 with the floor portion in an extended position.

FIG. 33 is a perspective view of a vehicle having a movable floor portion of FIGS. 30-32 and another embodiment of an apparatus for configuring the cargo area of the vehicle.

FIG. 34 is a perspective view of the vehicle of FIG. 33 with the floor portion in an intermediate position and the apparatus in an extended position.

### DESCRIPTION OF EMBODIMENTS OF THE INVENTION

The embodiments described below are merely exemplary and are not intended to limit the invention to the precise form disclosed. Instead, the embodiments were selected for description to enable one of ordinary skill in the art to practice the invention.

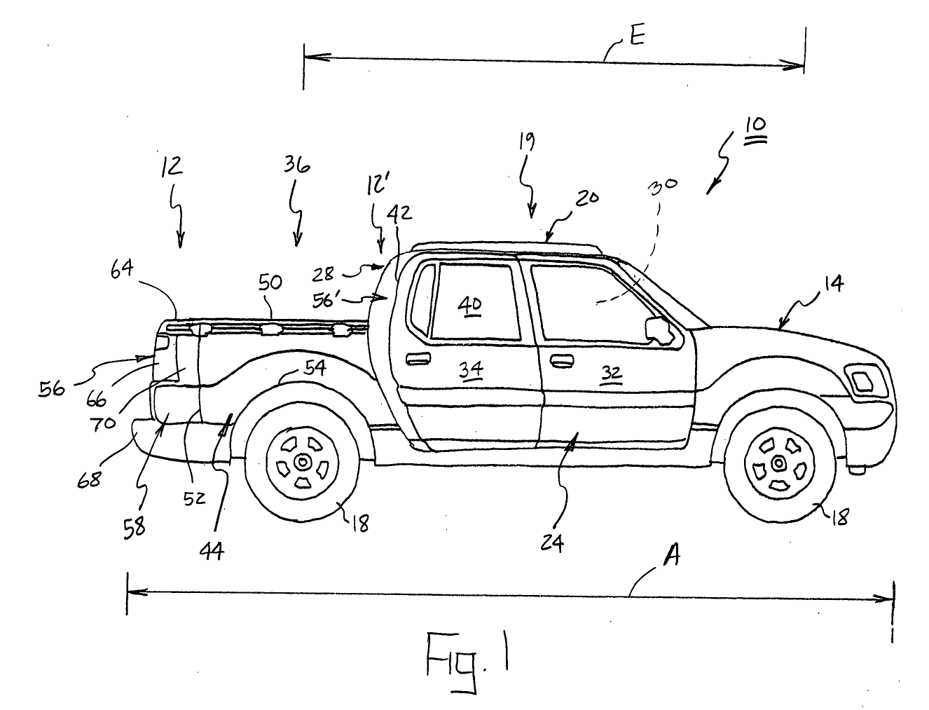

FIGS. 1-4 depict a vehicle 10 having an expansion portion 12 according to one embodiment of the present invention for providing an adjustable cargo area. While vehicle 10 may be any of a large variety of different types of vehicles having cargo areas, vehicle 10 is depicted and described herein as a pick-up truck. Vehicle 10 generally includes a body 14 mounted to a frame 16 (not shown) having wheels 18 connected thereto. Body 14 includes a cab 19 having a roof 20, a floor 22 (not shown), a first side 24, a second side 26, and a back end 28. Roof 20, floor 22, and sides 24, 26 define an interior space 30. Since first side 24 is substantially identical to second side 26, only first side 24 will be described herein. First side 24 includes, in this embodiment, a first door 32 and a second door 34. Second door 34 includes a window 40 and defines, with roof 20, an edge 42 as will be further described below.

Body 14 further includes a bed 36 connected to cab 19. Bed 36 includes a pair of side walls 44, 46, and a floor 48. Each side wall 44, 46 includes an upper edge 50, a rearward edge 52, and a wheel well 54. Side walls 44, 46 and floor 48 are configured to receive expansion portion 12.

Expansion portion 12 includes a rear wall 56, side walls 58, 60, and a lower wall 62. Rear wall 56 includes an upper edge 64, a tailgate 66 and a bumper section 68. Of course, instead of tailgate 66, rear wall 58 may include a full or partial swinging gate, or any other type of door opening to the cargo area. In the depicted embodiment, side walls 58, 60 each include an outer panel 70 and an inner panel 72 having a substantially continuous upper edge 74.

As best shown in FIG. 1, when expansion portion 12 is in the retracted position, outer panels 70 of side walls 58, 60 form a substantially continuous surface with bed side walls 44, 46, respectively. Outer panels 70 engage side walls 44, 46 along rearward edges 52. Upper edge 64 of rear wall 56 is also substantially continuous with upper edge 50 of bed side walls 44, 46. When expansion portion 12 is in the retracted position, expansion portion 12, bed 36, and back end 28 of cab 19 define a first cargo area. As will be apparent from the following description, when expansion portion 12 is in the retracted position, both the length of vehicle 10 (referenced by the letter “A”) and the defined cargo area are at minimum values.

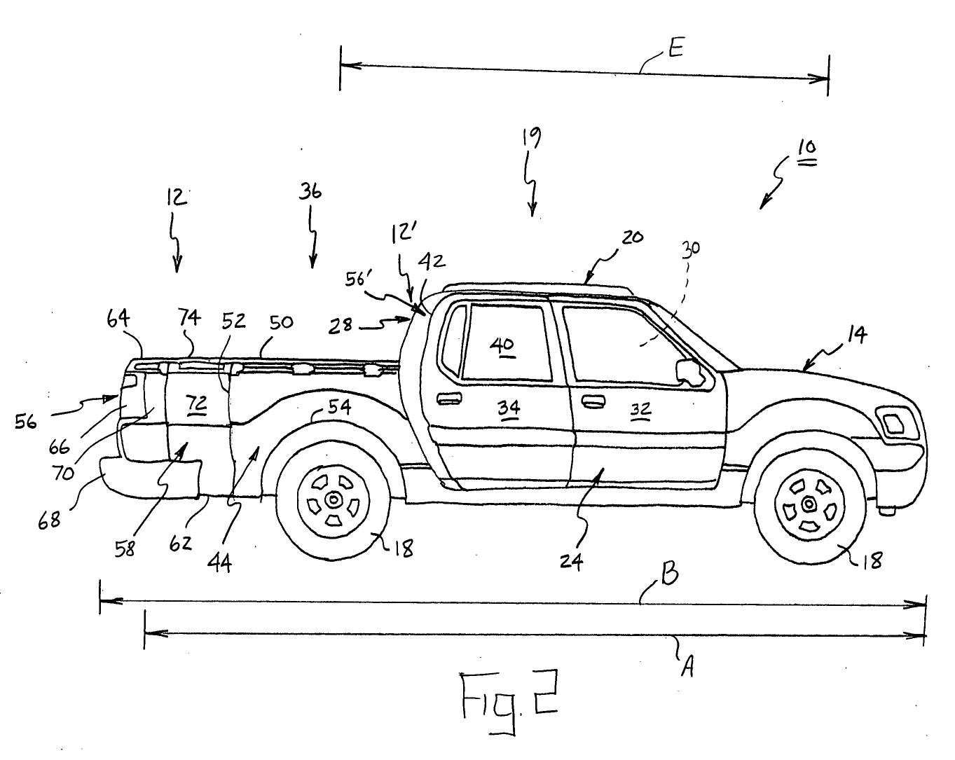

Referring now to FIG. 2, when expansion portion 12 is moved to the extended position, inner panels 72 of side walls 58, 60 extend from bed side walls 44, 46 and lower wall 62 extends from bed floor 48. When expansion portion 12 is in the extended position, expansion portion 12, bed 36, and back end 28 of cab 19 define a second cargo area that is larger than the first cargo area. Moreover, the defined cargo area of vehicle 10 is at a maximum value, and the length of vehicle 10 is expanded to length “B.” It should be understood, however, that expansion portion 12 may be configured such that its position relative to bed 19 is infinitely adjustable between the retracted position and the extended position.

In the embodiment shown, side walls 58, 60 are positioned between bed side walls 44, 46 when expansion portion 12 is in the retracted position. It should be understood, however, that side walls 58, 60 and bed side walls 44, 46 may be configured such that side walls 58, 60 are positioned within side walls 44, 46 or outside side walls 44, 46 when expansion portion 12 is in the retracted position in the manner taught U.S. Provisional Patent Application Ser. No. 60/476,155 entitled “Apparatus for Configuring the Interior Space of a Vehicle,” filed Jun. 5, 2003 (hereinafter, “the Interior Space Application”), the entire disclosure of which is hereby expressly incorporated herein by reference. It should also be understood that lower wall 62 of expansion portion 12 and bed floor 48 may be configured such that lower wall 62 moves under, over, or within bed floor 48 as expansion portion 12 is moved between the retracted position and the extended position. Moreover, the engagement surfaces between bed 36 and expansion portion 12 when expansion portion 12 is in either the retracted position or the extended position may include components for forming a seal (such as those described in the Interior Space Application) to prevent leaks from the cargo area through the sides or bottom of bed 36.

Additionally, a variety of different support and actuation mechanisms may be used to move expansion portion 12 between the retracted position and the extended position as described in the Interior Space Application. Finally, it should be understood that wiring to the various components of expansion portion 12 must be configured to accommodate movement of expansion portion 12.

As should be apparent from the foregoing, expansion portion 12 may be moved to the extended position to increase the cargo carrying capacity of vehicle 10, and then retracted to the retracted position to reduce the cargo carrying capacity and to permit easier parking of vehicle 10 in, for example, a garage having a conventional depth.

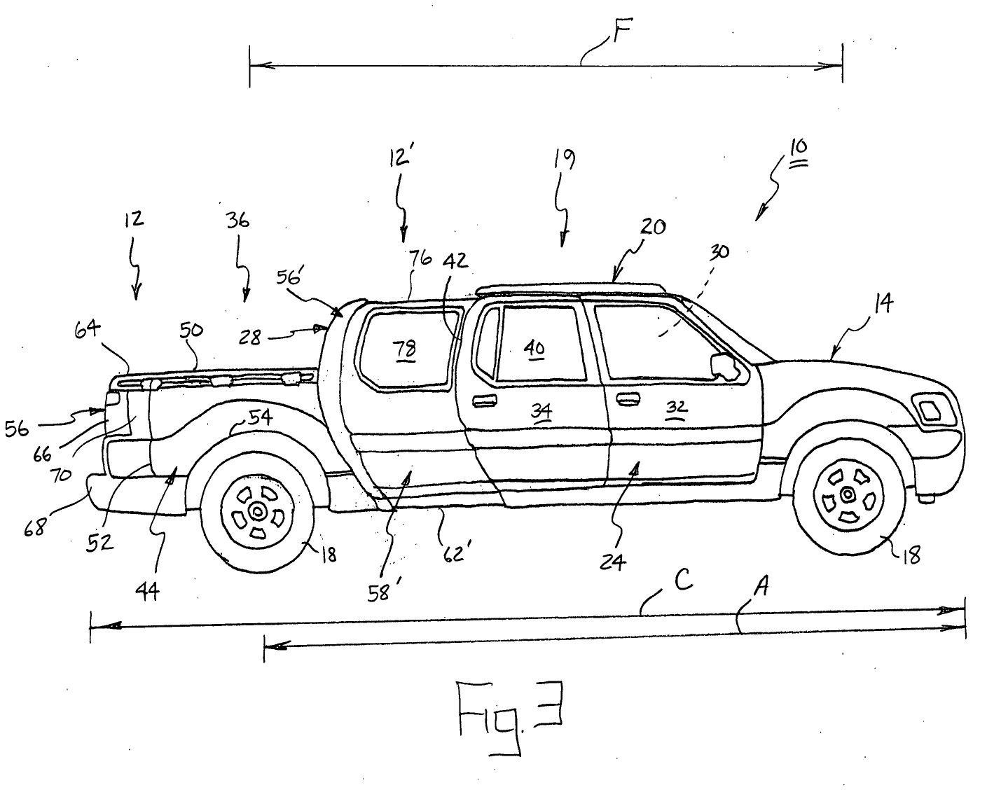

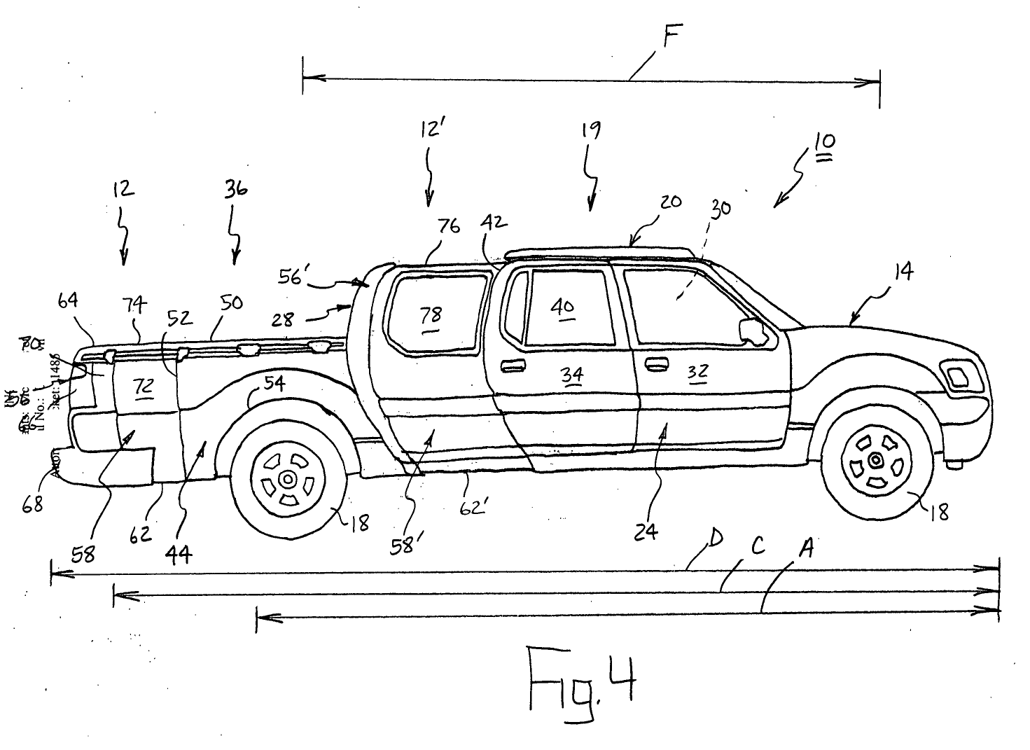

In another embodiment, vehicle 10 may further include an auxiliary expansion portion 12′ as shown in FIGS. 3 and 4. Any of the expansion portion features described in the Interior Space Application may readily be incorporated into auxiliary expansion portion 12′. Auxiliary expansion portion 12′ includes a rear wall 56′, a pair of side walls 58′, 60′, a lower wall 62′, and an upper wall 76. Each side wall 58′, 60′ is shown as including a window 78. In the embodiment shown, auxiliary expansion portion 12′ is rigidly connected to bed 36 and movably connected to cab 19. More particularly, when in the retracted position (FIGS. 1 and 2), auxiliary expansion portion 12′ is retracted substantially within cab 19, with rear wall 56′ sealing against rear edge 42 of roof 20 and second doors 34 to define a first interior space of cab 19. Additionally, windows 78 of side walls 58′, 60′ are substantially aligned with windows 40 of second doors 34. When moved to the extended position (FIGS. 3 and 4), auxiliary expansion portion 12′, bed 26, and expansion portion 12, are spaced away from cab 19 to reveal upper wall 76, side walls 58′, 60′, and lower wall 62′. It should be understood that when auxiliary expansion portion 12′ is in the extended position, portions of upper wall 76, side walls 58′, 60′, and lower wall 62′ seal against surfaces of cab 19 to define a second interior space of cab 19, which is larger than the first interior space. Windows 78 of side walls 58′, 60′ are also exposed, thereby increasing the window area of cab 19. Additionally, the length of vehicle 10 is increased from length A (FIG. 1) to length C (FIG. 3). As shown in FIG. 4, the length of vehicle 10 (as well as the cargo area of bed 36) may be further increased to length D by moving expansion portion 12 to the extended position as described above.

As should be apparent from the figures, movement of auxiliary expansion portion 12′ from the retracted position to the extended position also increases the wheelbase of vehicle 10 from wheelbase E shown in FIGS. 1 and 2 to wheelbase F shown in FIGS. 3 and 4. Accordingly, frame 16 of vehicle 10 (as well as the drive train, and wiring and plumbing extending from the forward portion of vehicle 10 to the rearward portion of vehicle 10) should be configured to expand and retract.

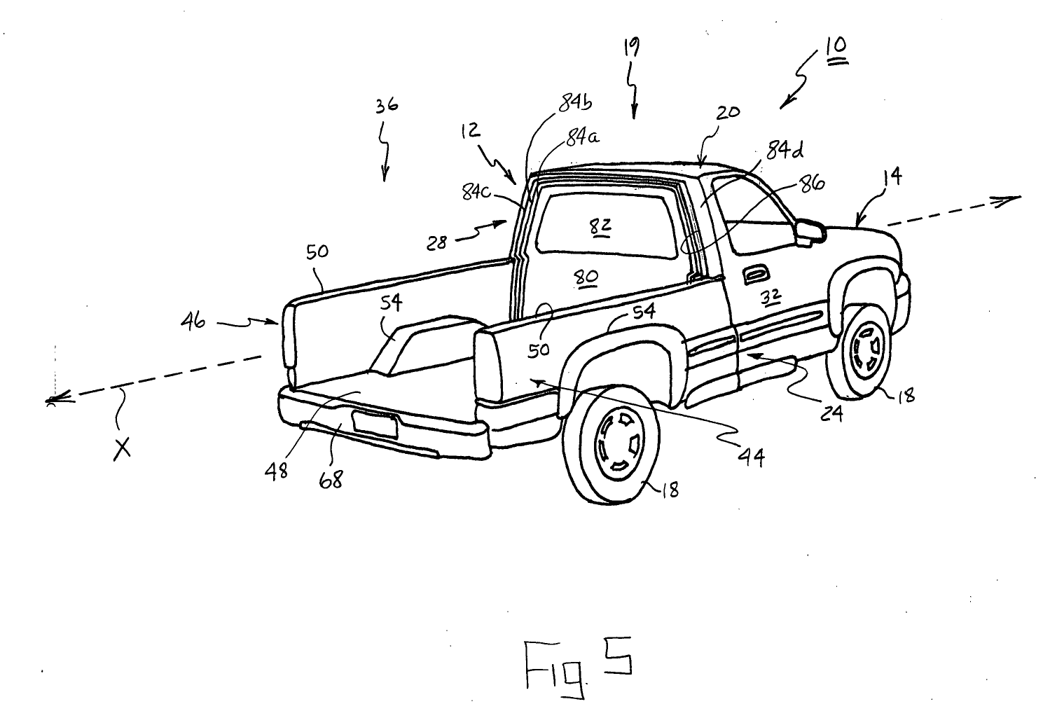

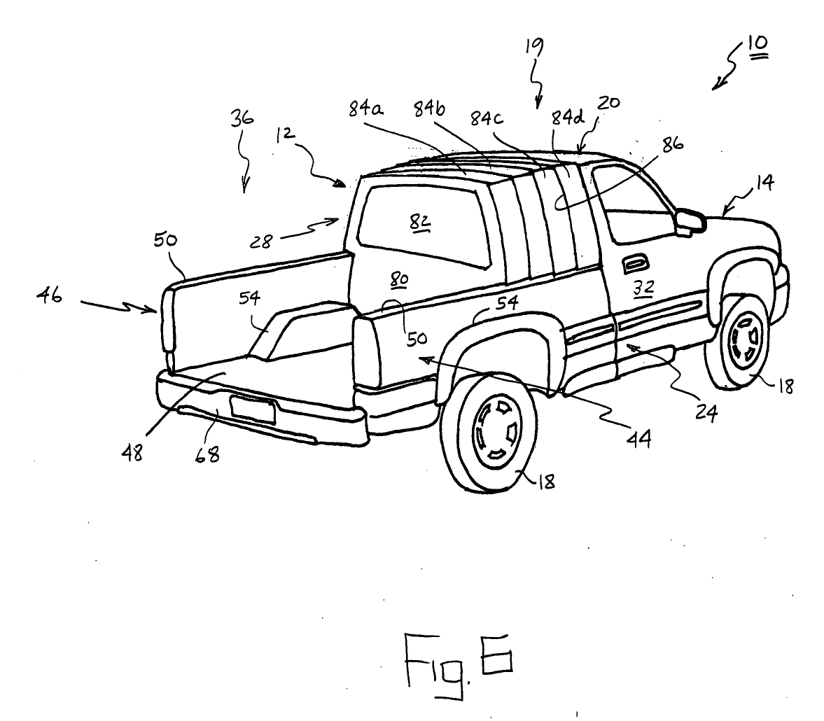

FIGS. 5 and 6 show an alternative embodiment of an apparatus for configuring the cargo area of a vehicle. It should be noted that in this embodiment, and many that follow, rear wall 56 and tailgate 66 are not shown for clarity. In this embodiment, expansion portion 12 is shown mounted to back end 28 of cab 19. Expansion portion 12 includes a rear wall 80 having a window 82, and a plurality of telescopic side sections 84a-d. As best shown in FIG. 5, when expansion portion 12 is in the retracted position, sections 84a-c telescope within one another and within section 84d, and rear wall 80 is substantially planer with a rearward edge 86 of telescopic section 84d. In this retracted position, expansion portion 12, along with the other components of bed 36, define a first cargo area. Additionally, expansion portion 12, along with additional components of cab 19, define a first interior space of cab 19. When expansion portion 12 is moved along the longitudinal axis X of vehicle 10 to the extended position shown in FIG. 6, telescopic section 84a-d extend relative to one another and rear wall 80 is moved toward wheel wells 54 of bed 36. In the extended position, rear wall 80 of expansion portion 12, along with other components of bed 36, define a second cargo area that is smaller than the first cargo area shown in FIG. 5. Additionally, expansion portion 12, along with additional components of cab 19, define a second interior space of cab 19 that is larger than the first interior space shown in FIG. 5.

Any of a variety of different actuation mechanisms may be used to move expansion portion 12 between the extended position and the retracted position (or any position therebetween). Such actuation mechanisms may be configured to provide sufficient force to move, not only expansion portion 12 to the extended position, but cargo resting on floor 48 of bed 36. In this manner, movement of expansion portion 12 from the retracted position to the extended position not only reconfigures the size of the cargo area of bed 36 and the interior space of cab 19, but also provides a mechanism for assisting unloading of cargo from bed 36. It should be understood that cargo positioned near the forward portion of bed 36 may be moved toward the rearward portion of bed 36 by extending expansion portion 12 from the retracted position to the extended position. By again moving expansion portion 12 to the retracted position, inserting a spacer (not shown) between rear wall 80 and the previously moved cargo in bed 36, then again moving expansion portion 12 to the extended position, a user may further push the cargo toward the rearward portion of bed 36.

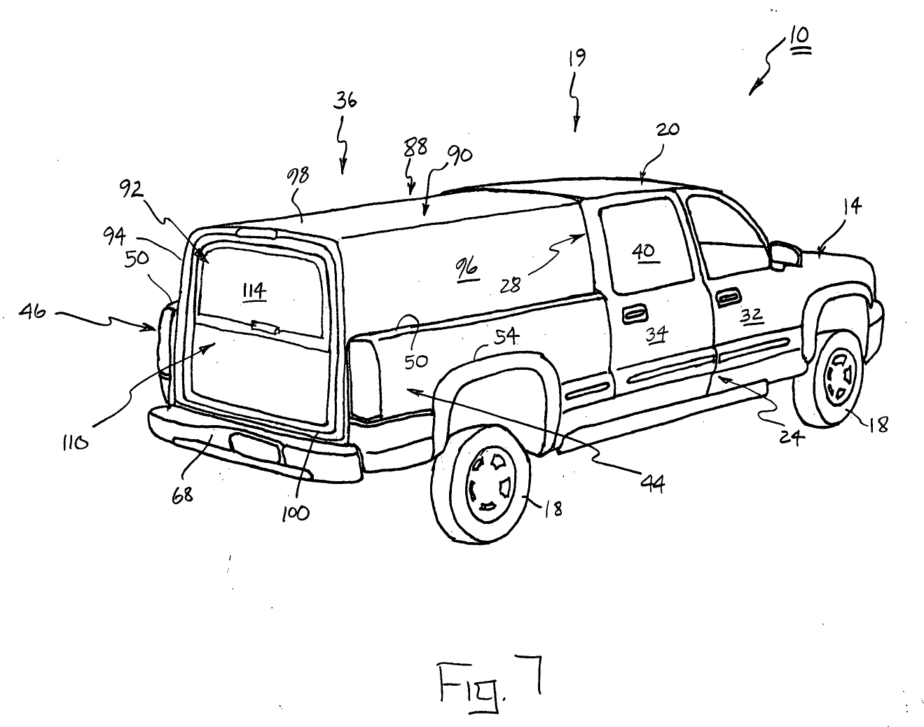

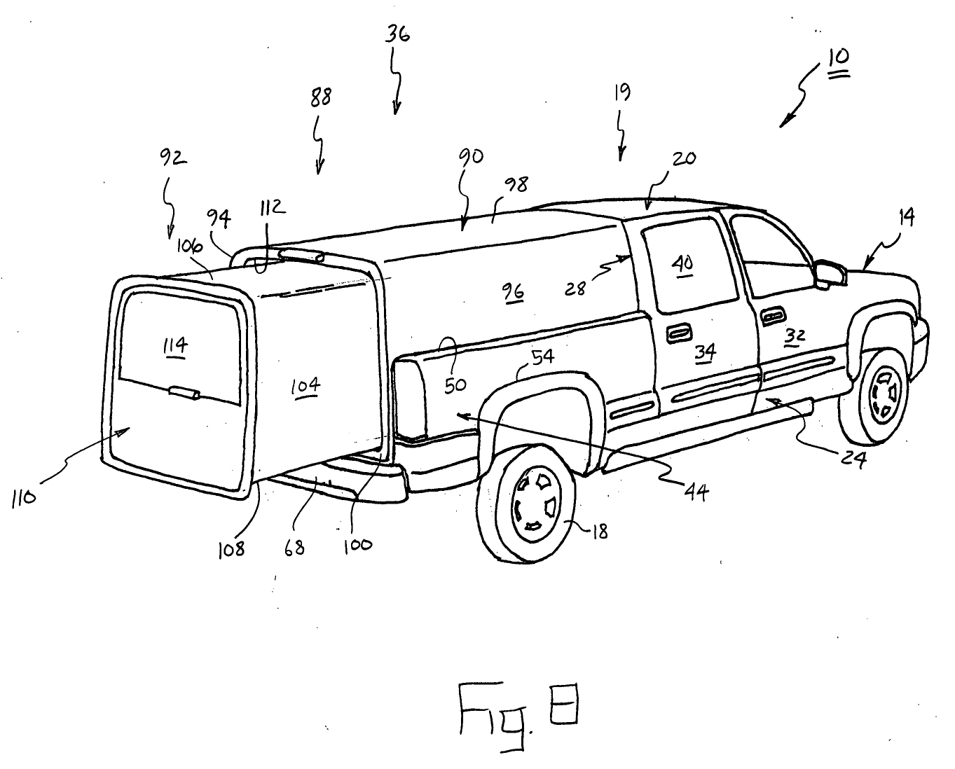

FIGS. 7 and 8 show another embodiment of an apparatus for configuring the cargo area of a vehicle. In this embodiment, a container 88 is sized to fit within bed 36 of vehicle 10. Container 88 generally includes a housing 90 and an expandable insert 92. Housing 90 includes side walls 94, 96, upper wall 98, and lower wall 100. Housing 90 may further include a back wall (not shown) adjacent back end 28 of cab 19 when container 88 is installed in bed 36. As best shown in FIG. 8, expandable insert 92 also includes a pair of side walls 102, 104, an upper wall 106, a lower wall 108, and a rear wall 110. The outer dimensions of expandable insert 92 are configured such that it is moveable within the interior space of housing 90. Rear wall 110 may include a window 114, such as a hatch style window, and a drop down door (not shown) for accessing the interior space defined by expandable insert 92 and housing 90.

Container 88 may be mounted in bed 36 using convention fasteners or any other type of attachment technology. If housing 90 includes a back wall (not shown), such a back wall may include a window to permit viewing from the interior space of cab 19 through a convention rear window of cab 19, the window of the back wall, and window 114 of rear wall 110. When in the retracted position shown in FIG. 7, container 88 defines a substantially enclosed cargo area in bed 36 of vehicle 10. The volume of the interior space of this cargo area may be increased by moving expandable insert 92 to the extended position shown in FIG. 8. Any of a variety of actuation and support mechanisms may be employed to move expandable insert 92 between the extended position and the retracted position.

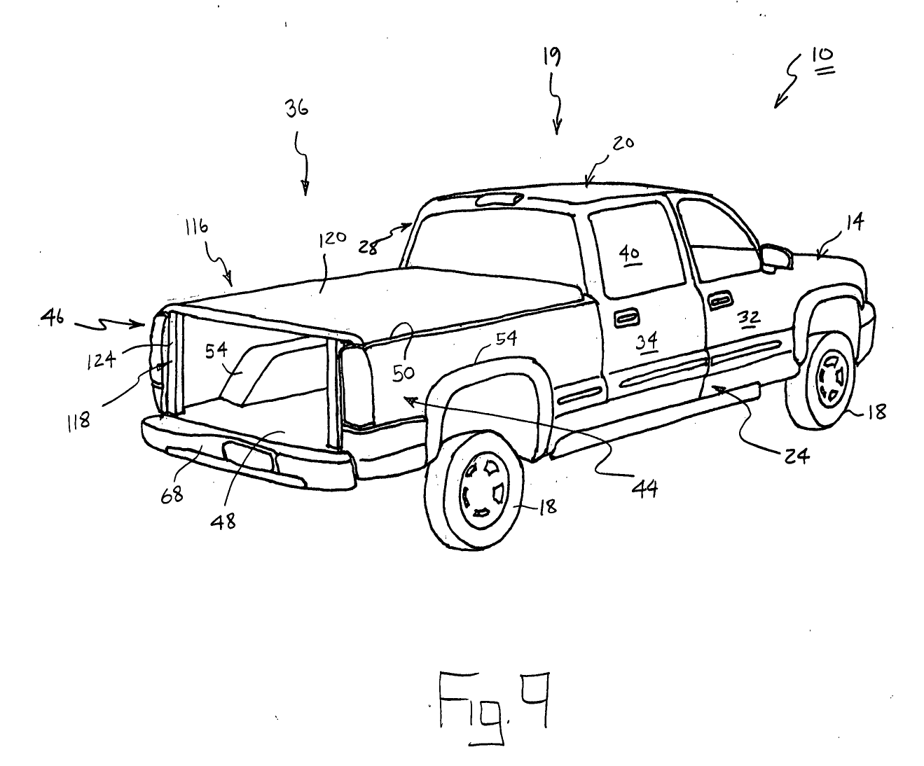

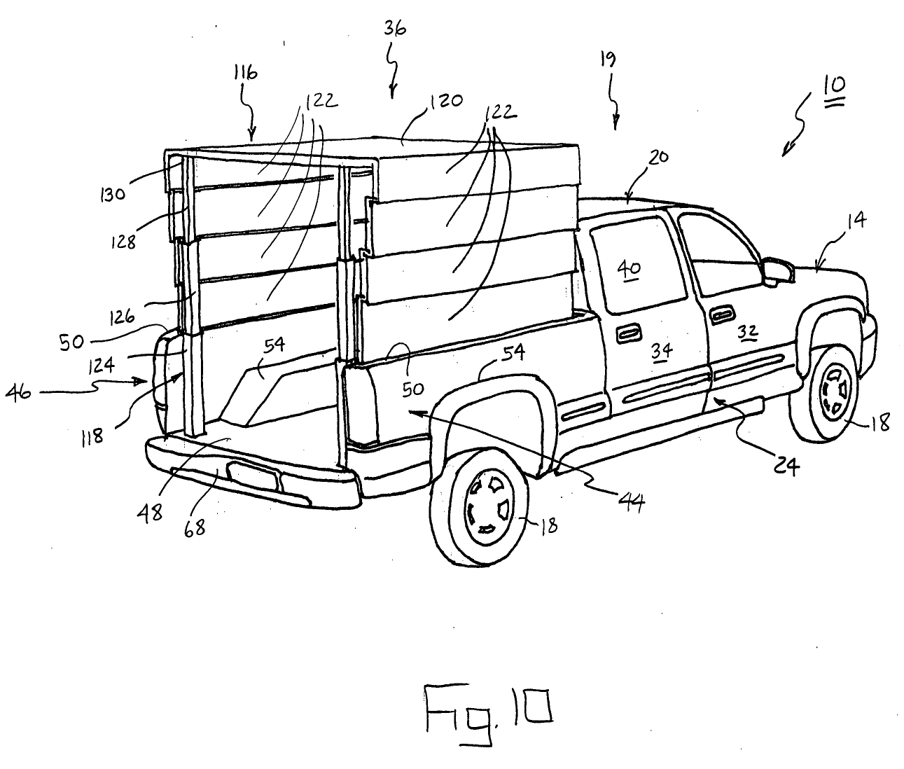

FIGS. 9 through 25 depict a plurality of embodiments of vertically expandable cargo areas according to the present invention. FIGS. 9 and 10 depict an adjustable cover 116 including a plurality of support and actuation assemblies 118, an upper wall 120 that spans between side walls 44, 46 of bed 36 substantially the entire length of bed 36, and a plurality of side panels 122. Assemblies 118 each include a housing 124 shown attached to one of side walls 44, 46. It should be understood, however, that housings 124 may alternatively be mounted within the width of side walls 44, 46. Assemblies 118 further include a first telescoping segment 126 sized to fit within housing 124, and a second telescoping segment 128 sized to fit within first segment 126. One end 130 of second segment 128 is attached to a lower surface of upper wall 120.

When in the retracted position shown in FIG. 9, adjustable cover 116 essentially functions as a conventional tonneau cover. In the retracted position, adjustable cover 116 therefore defines (along with the other components of bed 36), a first cargo area having a first interior space. When adjustable cover 116 is moved to the extended position shown in FIG. 10, first telescopic segment 126 extends from housing 124 and second telescopic segment 128 extends from first telescopic segment 126 for each of support and actuation assemblies 118. As such, wall 120 is raised above upper edges 50 of side walls 44, 46. As upper wall 120 is moved upwardly, each side panel 122 engages an adjacent side panel 122, thereby drawing the adjacent side panel 122 upwardly to the positions shown in FIG. 10. It should be understood that adjacent side panels 122 may have mating surfaces that engage one another when adjustable cover 116 is moved to the extended position, thereby forming substantially continuous side walls that extend upwardly from bed side walls 44, 46.

Support and actuation assemblies 118 may be driven pneumatically, hydraulically, or electrically to raise and lower upper wall 120 between the extended position and the retracted position. Additionally, any of a plurality of different synchronization techniques may be used to ensure that assemblies 118 maintain upper wall 120 in a substantially horizontal orientation as it is moved between the extended position and the retracted position.

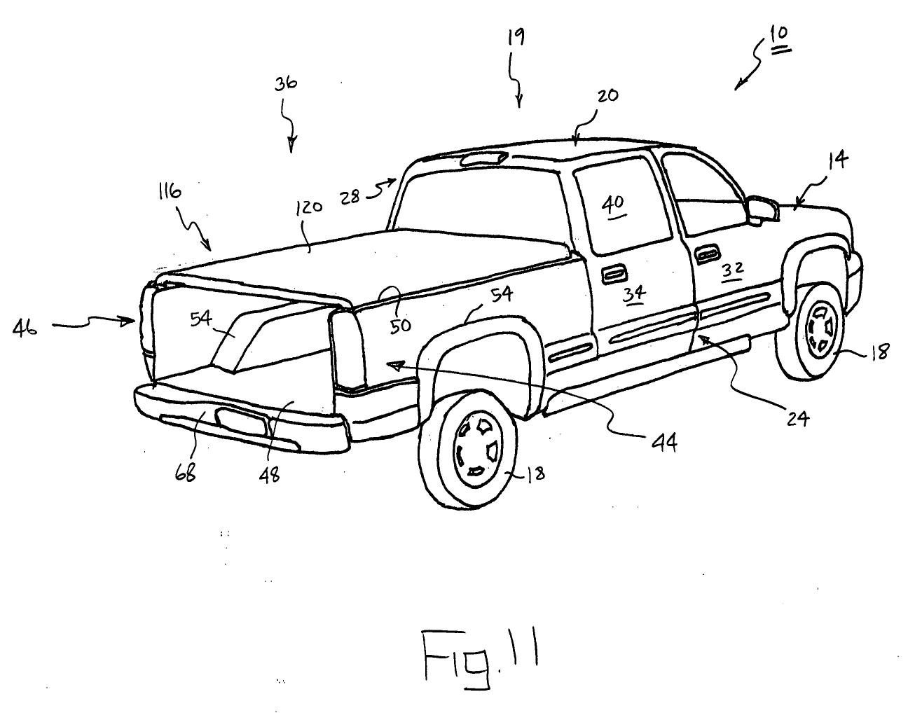

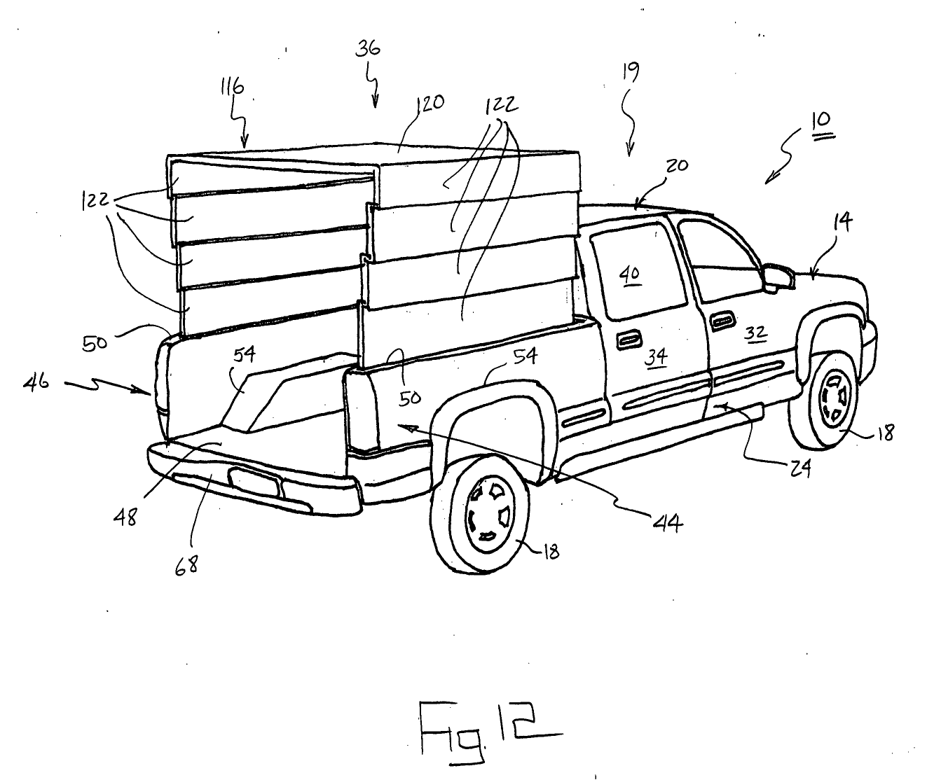

FIGS. 11 and 12 show another embodiment of adjustable cover 116 wherein support and actuation assemblies 118 have been eliminated. In this embodiment, adjustable cover 116 is moved manually between the extended position and the retracted position. Accordingly, side panels 122 may include locking mechanisms to retain each side panel in engagement with an adjacent side panel 122 to maintain adjustable cover 116 in the extended position shown in FIG. 12.

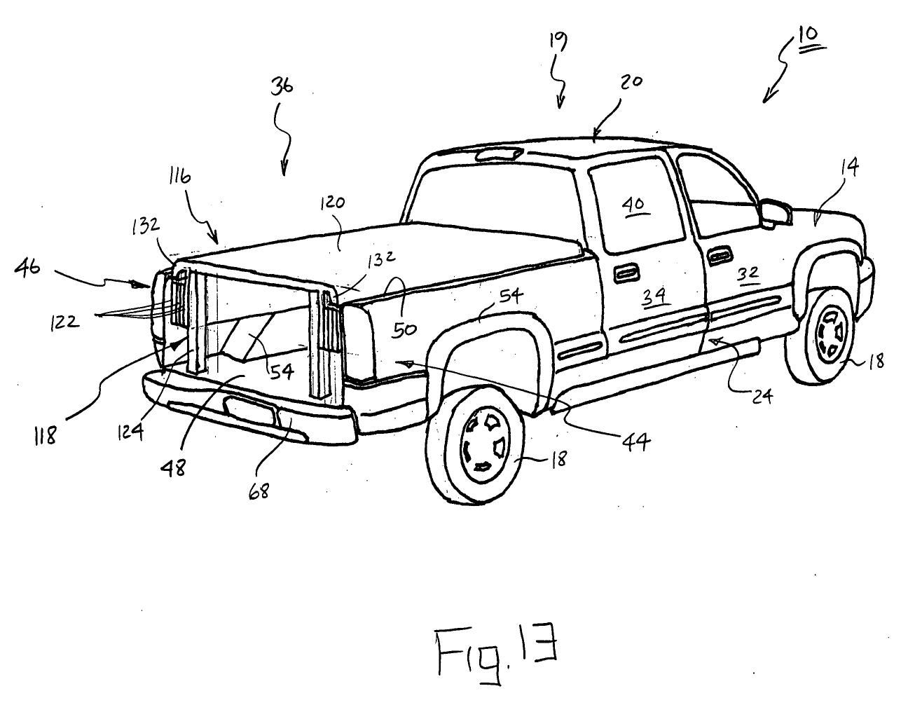

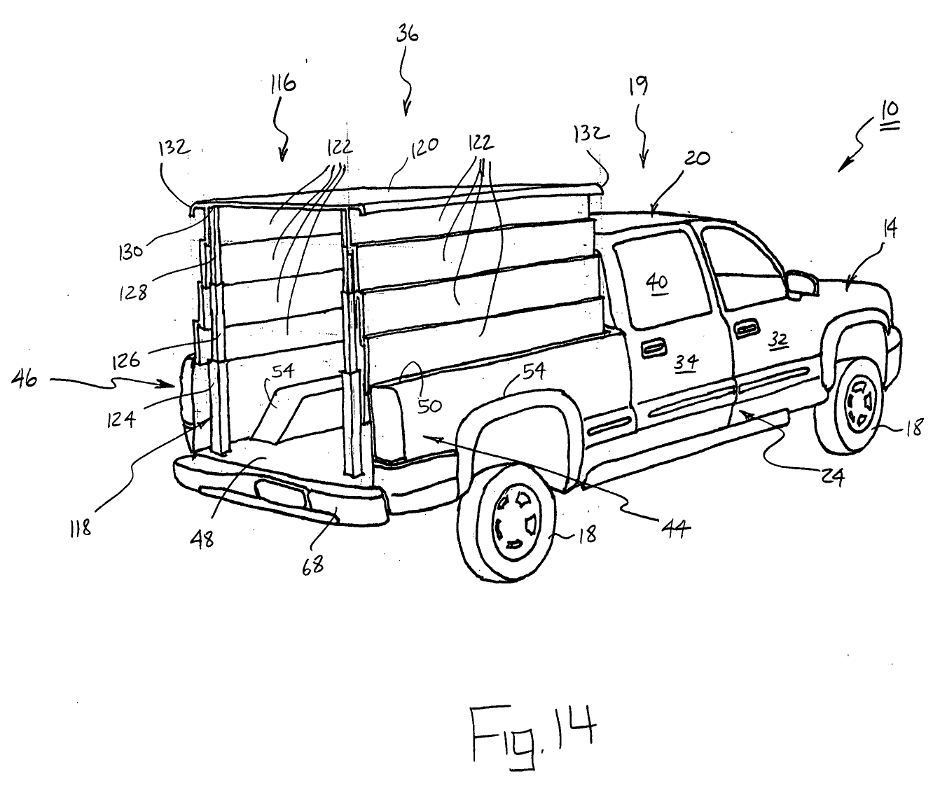

FIGS. 13 and 14 show yet another embodiment of an adjustable cover 116 according to the present invention. This embodiment is substantially similar to that shown in FIGS. 9 and 10 except for the arrangement of side panels 122 and the position of support and actuation assemblies 118. More particularly, whereas in the embodiment of FIGS. 9 and 10 the lower most side panels 122 connected to side walls 44, 46 are positioned inwardly relative to the upper most side panels 122 connected to upper wall 120, with the remaining side panels 122 positioned sequentially therebetween, in the embodiment of FIGS. 13 and 14, the upper most side panels 122 are positioned inwardly relative to the lower most side panels 122, with the remaining side panels positioned sequentially therebetween. As a result, whereas the side panels 122 of FIGS. 9 and 10 may be positioned within an interior cavity (not shown) of bed side walls 44, 46 when adjustable cover 116 is in the retracted position, side walls 122 of the embodiment of FIGS. 13 and 14 are depicted as being positioned within the cargo area of bed 36 when adjustable cover 116 is in the retracted position.

To accommodate the collective widths of side panels 122, support and actuation assemblies 118 may be connected to floor 48 of bed 36 in spaced apart relationship from the interior surfaces of side walls 44, 46. Additionally, upper wall 120 is shown as having overhanging portions 132 to accommodate the collective widths of panels 122 and rest on upper edges 50. Of course, it should be understood that a cavity may also be provided within side walls 44, 46 for receiving side panels 122 of the arrangement shown in FIGS. 13 and 14. In such an embodiment, housings 124 of assemblies 118 may be mounted to side walls 44, 46 and over hanging portions 132 may be eliminated.

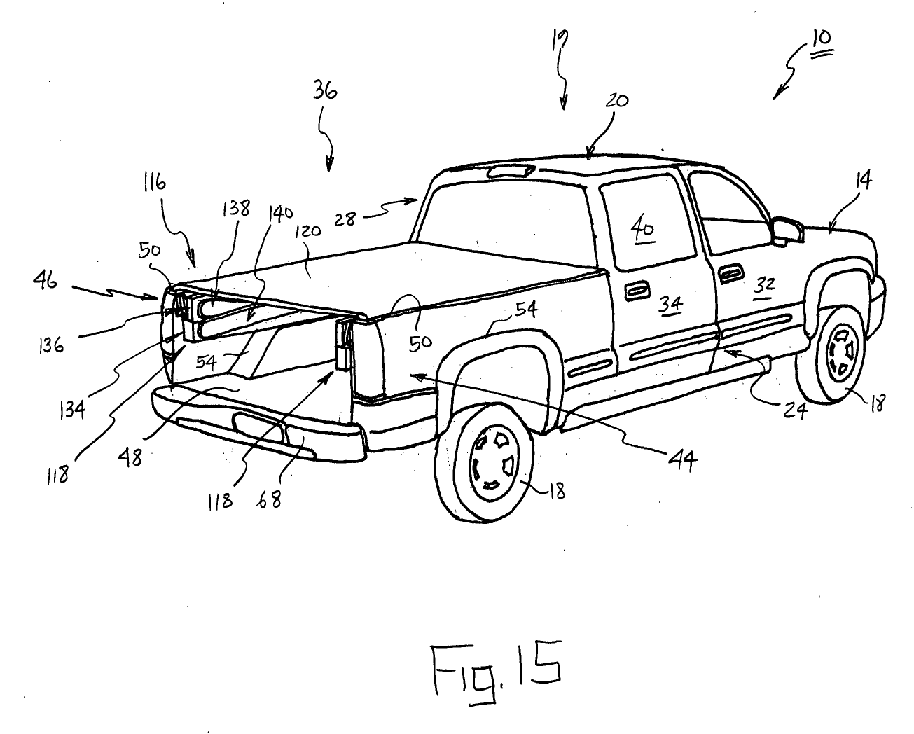

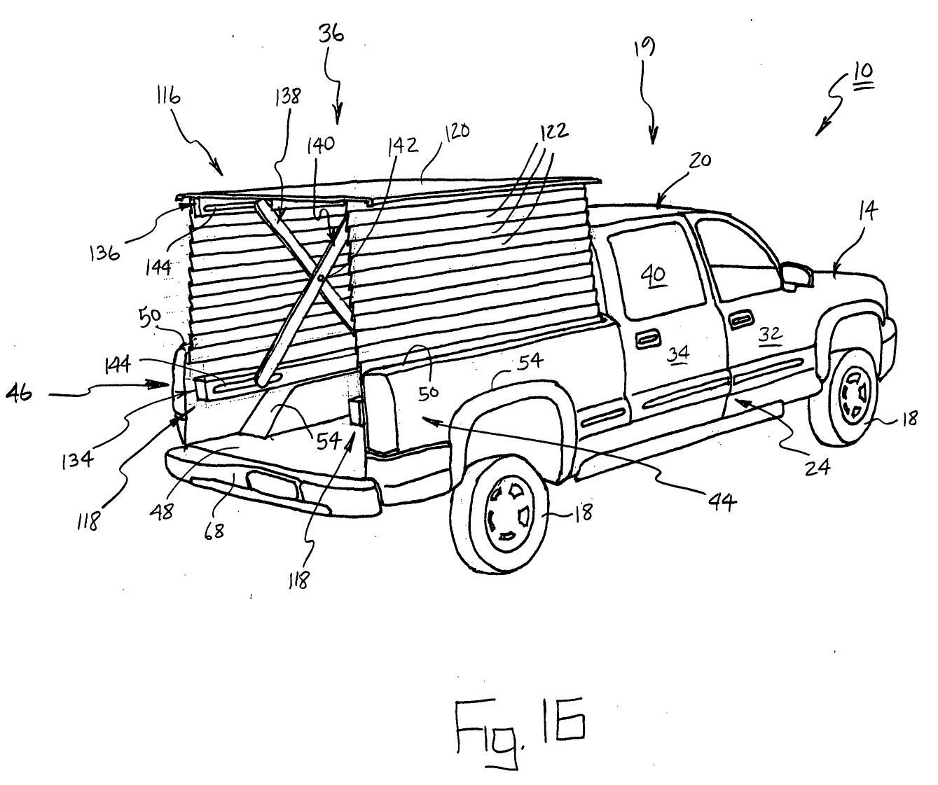

Referring now to FIGS. 15 and 16, another embodiment of an adjustable cover 116 is shown. In this embodiment, support and actuation assemblies 118 each include a lower bracket 134, an upper bracket 136, and a pair of braces 138, 140 that are positioned to cross one another and moveably connected to one another by a pivot pin 142. Lower brackets 134 are mounted to side walls 44, 46 in substantially parallel relationship to upper edge 50 of side walls 44, 46. Each lower bracket 134 includes a rearward slot 144 and a forward slot 146 (not shown). A pin (not shown) attached to the lower end of brace 140 rides within rearward slot 144, and a pin (not shown) attached to the lower end of brace 138 rides within forward slot 146. Upper brackets 136 are mounted adjacent the lower surface of upper wall 120, and similarly include rearward slots 144 and forward slots 146 (not shown) for receiving pins located at respective ends of braces 138,140.

As should be apparent from the figures, when adjustable cover 116 is in the retracted position of FIG. 15, upper wall 120 functions as a convention tonneau cover. Additionally, upper bracket 136 is positioned substantially adjacent to lower bracket 134. Additionally, the pins at the ends of braces 138, 140 are positioned adjacent the forward most ends of forward slots 146 and the rearward most ends of rearward slots 144. As adjustable cover 116 is moved to the extended position of FIG. 16, the upper ends and lower ends of braces 138, 140 are moved toward one another and the corresponding pins move within the corresponding slots to the positions shown in FIG. 16. Braces 138, 140 may be moved through this scissor-like motion by drawing the lower ends or the upper ends (or both the lower ends and the upper ends) of braces 138,140 toward one another using a cable and pulley system, electric motors, or any other suitable actuation technique. It should also be understood that a locking mechanism may be incorporated into adjustable cover 116 to maintain braces 138, 140 in the position shown in FIG. 16. Of course, a release mechanism may also be included to either manually or automatically permit movement of braces 138, 140 from the position shown in FIG. 16 to the position shown in FIG. 15. FIG. 16 also illustrates the fact that any number of side panels 122 may be provided to form the side walls of adjustable cover 116 when in the extended position.

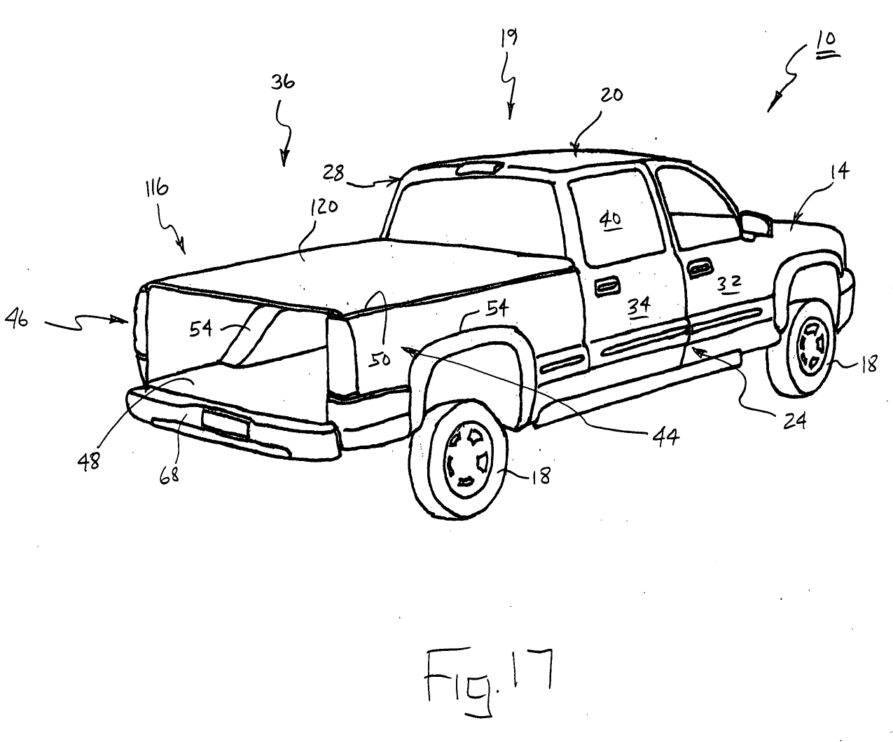

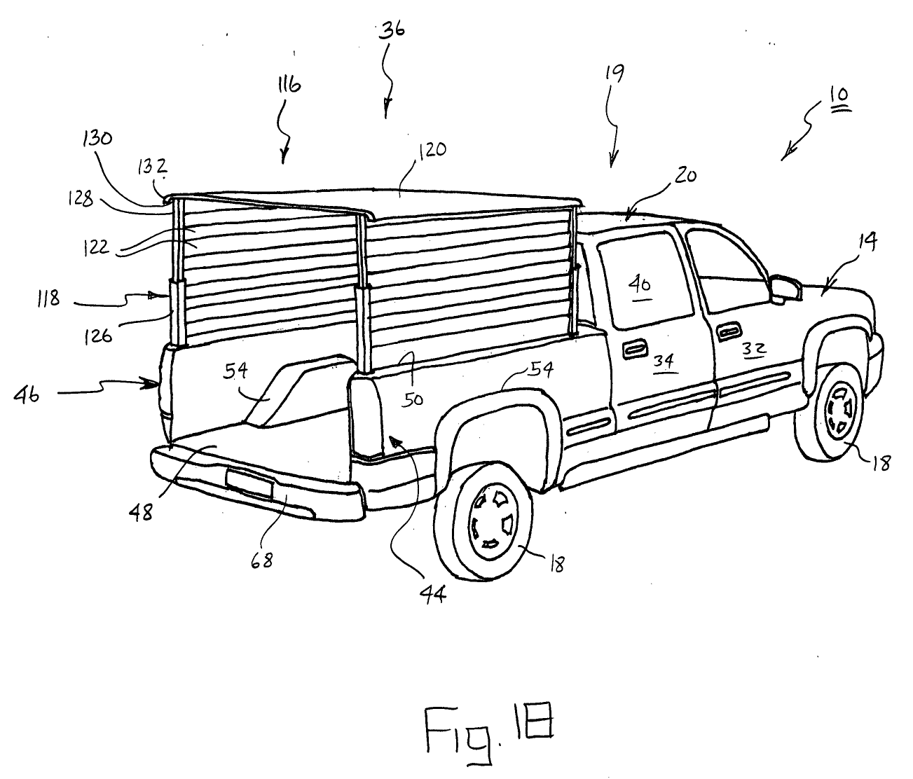

FIGS. 17 and 18 show yet another embodiment of an adjustable cover 116 according to the present invention. In this embodiment, support and actuation assemblies 118 are mounted such that they are retracted substantially entirely within interior cavities (not shown) of bed side walls 44, 46. More specifically, housings 124 of assemblies 118 are mounted within side walls 44, 46 such that segments 126, 128 extend upwardly from within side walls 44, 46 to drive upper wall 120 from the retracted position of FIG. 17 to the extended position of FIG. 18. Suitable connection structure may be provided such that first and second segments 126,128 of each assembly 118 are substantially continuously connected to the adjacent ends of panels 122 to form corner edges of the space enclosed by adjustable cover 116 when in the extended position.

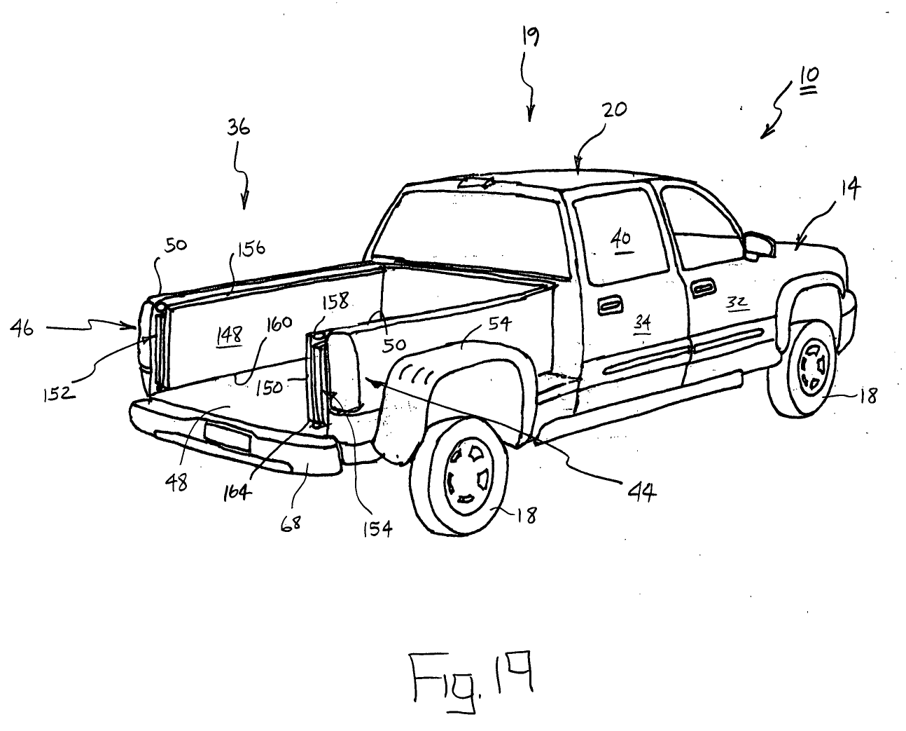

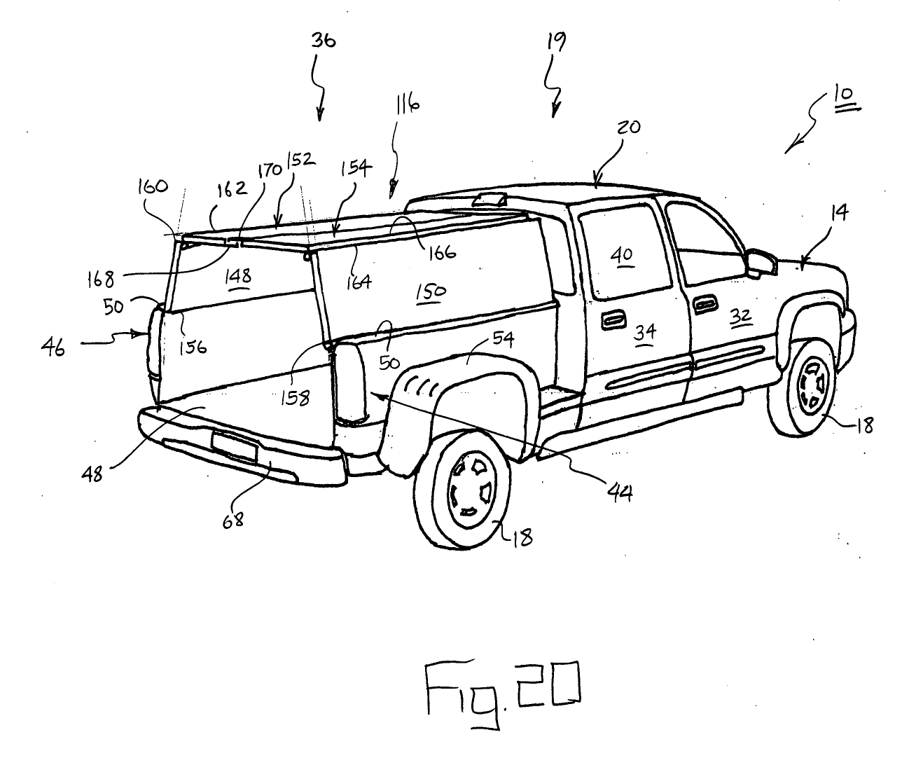

FIGS. 19 and 20 show another embodiment of the an adjustable cover 116 according to the present invention. In this embodiment, adjustable cover 116 includes a pair of side segments 148, 150 and a pair of top segments 152, 154. Side segment 148 includes a first edge 156 that is pivotally connected adjacent upper edge 50 of sidewall 46, and side segment 150 includes a first edge 158 that is pivotally connected adjacent upper edge 50 of sidewall 44. A second edge 160 of side segment 148 is pivotally connected to a first edge 162 of top segment 152. Similarly, a second edge 164 of side segment 150 is pivotally connected to a first edge 166 of top segment 154. Top segment 152 further includes a free edge 168 formed to underlap, overlap, or otherwise mate with a free edge 170 of top segment 154 when adjustable cover 116 is in the extended position shown in FIG. 20.

When adjustable cover 116 is in the retractable position of FIG. 19, top segment 152 is folded against side segment 148 such that when side segment 148 is pivoted downwardly into a substantially parallel orientation relative to sidewall 46, top segment 152 is positioned between an inner surface of sidewall 46 and an inner surface of side segment 148. Similarly, top segment 154 is positioned between side segment 150 and bed side wall 44. Latches or other locking mechanisms may be provided to retain the segments in this retracted position. A user may manually reconfigure the cargo area of bed 36 by pivoting side segments 148, 150 upwardly to the position shown in FIG. 20, then pivoting top segments 152, 154 upwardly such that free edges 168, 170 engage one another. Additionally, latches or other locking mechanisms may be provided to retain the segments in the extended position shown in FIG. 20. It should be noted that side segments 148, 150 tilt slightly inwardly toward one another when adjustable cover 116 is in the extended position. It should further be noted that additional flaps (not shown) may be provided such that they fold downwardly and/or inwardly from side segments 148, 150 and/or top segments 152, 154 to substantially enclose the rear opening formed by adjustable cover 116 above the tailgate (not shown) when adjustable cover 116 is in the extended position.

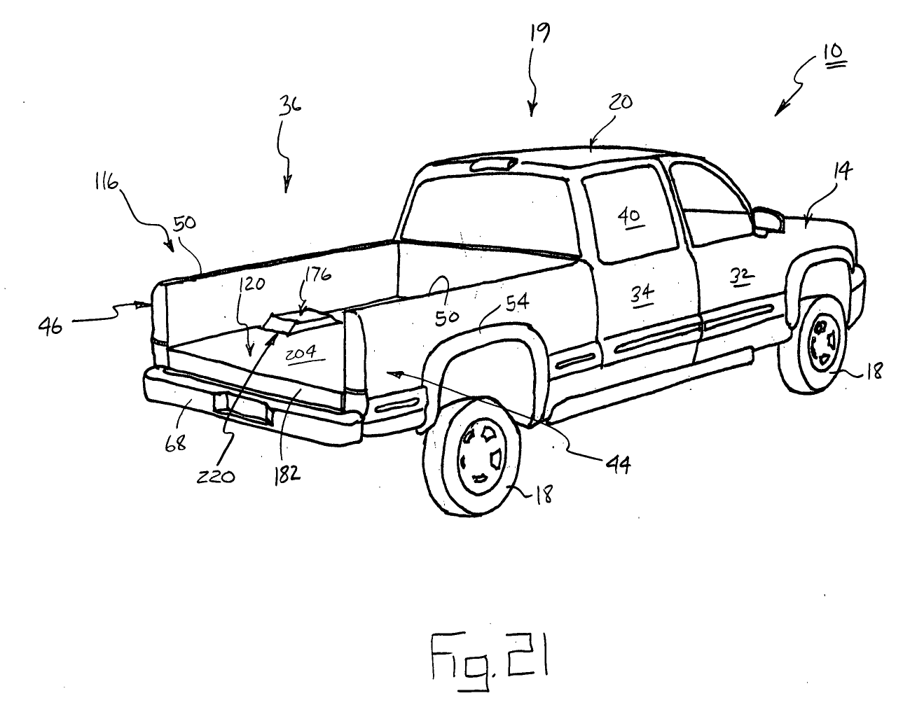

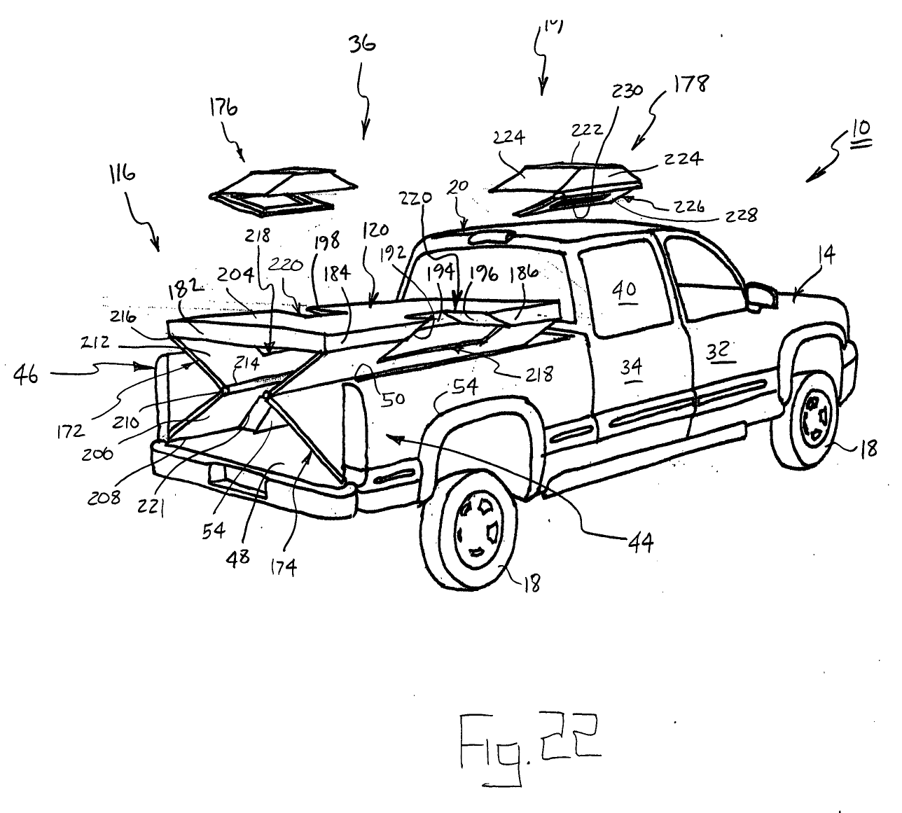

FIGS. 21-23 show yet another embodiment of an adjustable cover 116 according to the present invention. As is best shown in FIG. 22, adjustable cover 116 generally includes an upper wall 120, a pair of foldable side walls 172, 174, and a pair of removable inserts 176, 178. Upper wall 120 includes a top panel 204, a forward vertical segment 180 (not shown), a rearward vertical segment 182, four side vertical segments 184, 186, 188, 190, and six side angled segments 192, 194, 196, 198, 200, 202. Segments 180-202 and top panel 204 of upper wall 120 together define an interior space of upper wall 120 for receiving side walls 172,174 is further described below.

Since side walls 172, 174 are substantially identical to one another, only side wall 174 will be described in detail herein. Side wall 172 includes a lower segment 206 have a lower edge 208 and an upper edge 210, and an upper segment 212 have a lower edge 214 and an upper edge 216. Upper edge 216 of upper segment 212 defines a notch 218 that is sized to clear wheel well 54 when adjustable cover 116 is in the retracted position as shown in FIG. 21. Lower segment 206 similarly includes a notch 221 sized to clear wheel well 54 when adjustable cover 116 is in the retracted position of FIG. 21. Additionally, side angled segments 192-202 of upper wall 120 define a pair of notches 220 that are sized to clear wheel wells 54 when adjustable cover 116 is in the retracted position. Lower edge 208 of lower segment 206 is pivotally attached to floor 48 of bed 36 adjacent side wall 46. Upper edge 210 of lower segment 206 is pivotally connected to lower edge 214 of upper segment 212. As should be apparent from the drawings, when adjustable cover 116 is in the retracted position of FIG. 21, side walls 172, 174 are folded to lie substantially flat on floor 48 of bed 36 within the interior space defined by top panel 204 and segments 180-202 of upper wall 120.

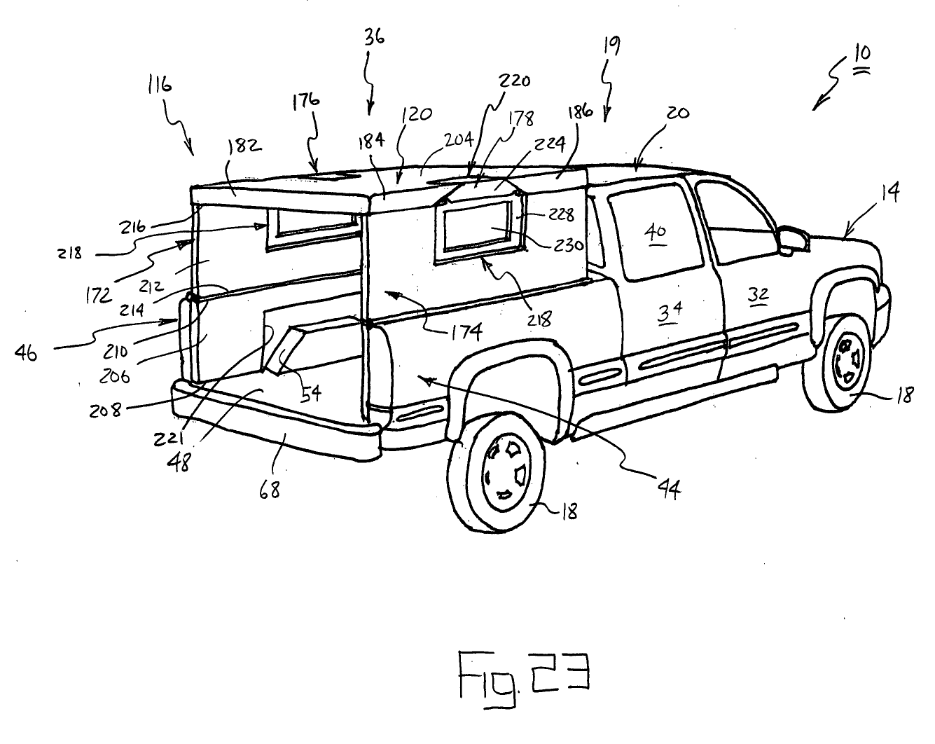

As shown in FIG. 22, each of removable inserts 176, 178 includes a top panel 222 and a plurality of side panels 224, which are configured to fit within a respective notch 218, 220 as best shown in FIG. 23. Each removable insert 176,178 also includes a window panel 226 having a frame 228 and a window section 230. Frame 228 is pivotally connected to a side wall 224 of each insert 176, 178. As should be apparent from the figures, inserts 176, 178 are sized to be positioned over wheel wells 54 when adjustable cover 116 is in the retracted position shown in FIG. 21. In this position, inserts 176, 178 (more specifically, portions of top panels 222 and side panels 224) extend partially through their respective notches 220 of upper wall 120. As adjustable cover 116 is moved toward the extended position, inserts 176, 178 may be removed to permit extension of side walls 172, 174 to the fully extended position of FIG. 23. Inserts 176, 178 may then be inserted in their respective notches 220 such that top panels 222 and side panels 224 of inserts 176, 178 substantially seal notches 220. Window panels 226 of inserts 176, 178 may then be pivoted downwardly and mated with notches 218 of upper segments 212 to form windows in adjustable cover 116 as shown in FIG. 23.

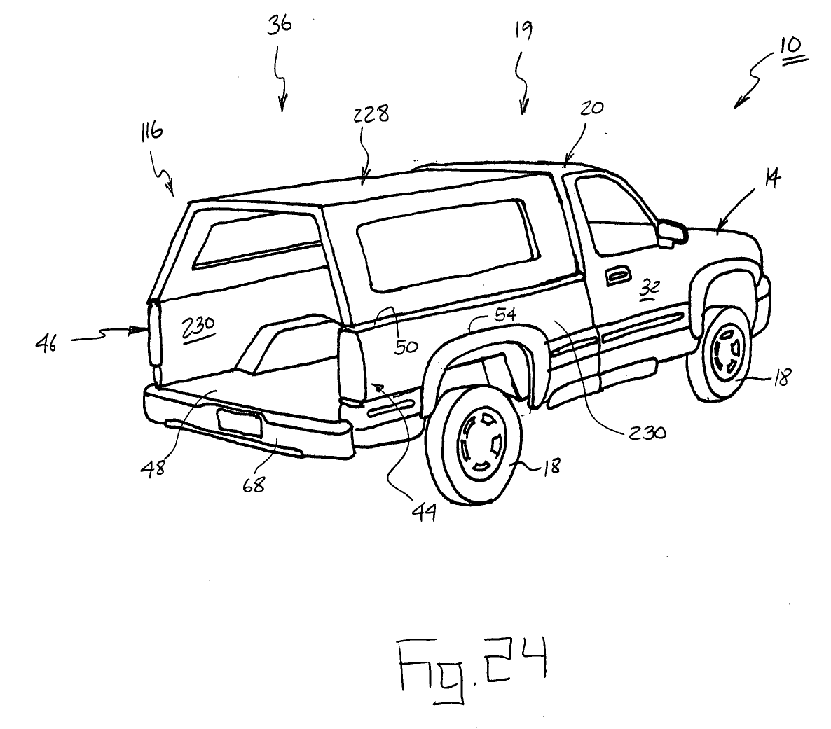

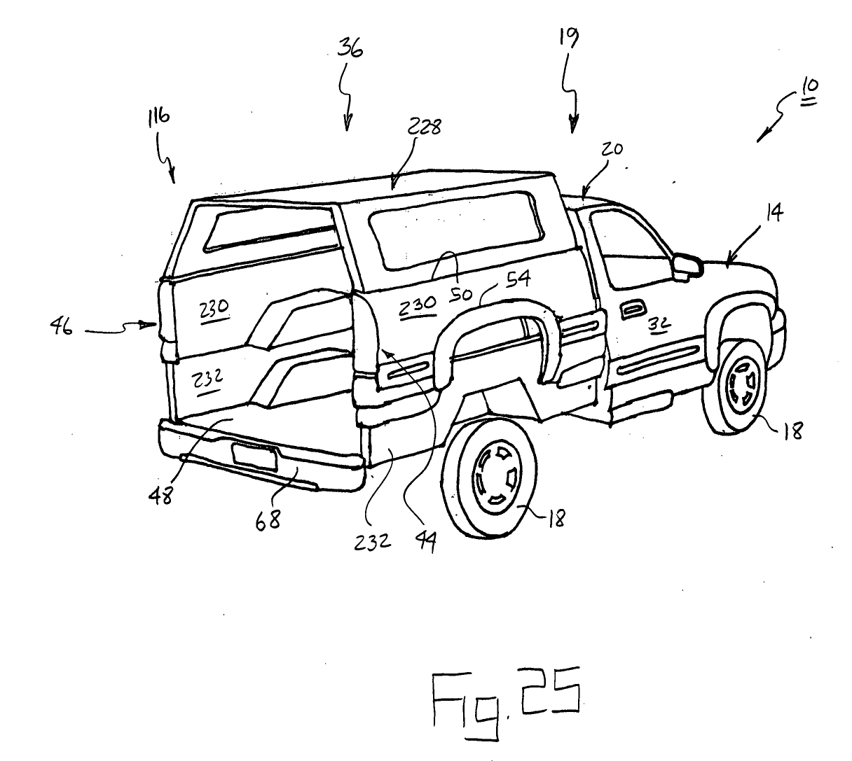

FIGS. 24 and 25 show an alternate embodiment of an adjustable cover 116 according to the present invention. In this embodiment, a conventional pickup truck cap 228 is connected to upper edges 50 of side walls 44, 46. As best shown in FIG. 25, side walls 44, 46 each include an outer panel 230 and an inner panel 232. When adjustable cover 116 is in the retracted position of FIG. 24, inner panels 232 fit within a cavity (not shown) formed in outer panels 230. Alternatively, guides or tracks may be formed in either of panels 230, 232 to enable outer panels 230 to move vertically, relative to inner panels 232. When adjustable cover 116 is moved to the extended position of FIG. 25, outer panels 230 of side walls 44, 46, and cap 228 are raised vertically relative to floor 48 of bed 36 to increase the vertical dimension of the cargo area of bed 36. It should be understood that any of a variety of support and actuation assemblies 118 may be used to move adjustable cover 116 between the extended position and the retracted position, and to support adjustable cover 116 when in the extended position of FIG. 25.

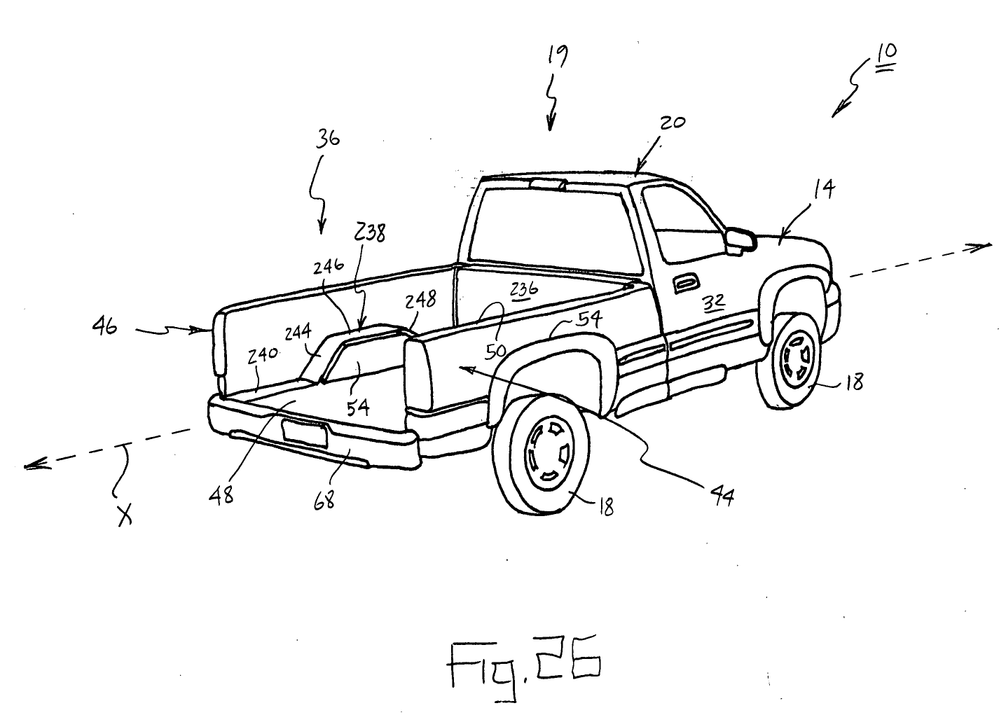

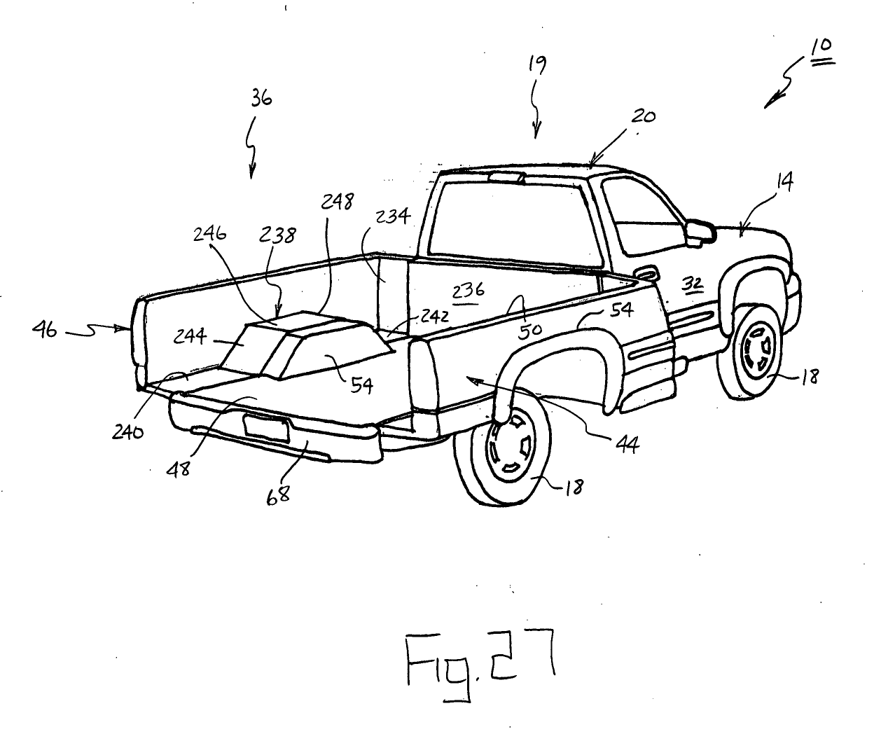

Referring now to FIGS. 26 and 27, another embodiment of an apparatus for configuring the cargo area of a vehicle is shown. In this embodiment, side walls 44, 46 of bed 36 extend laterally relative to longitudinal axis X of vehicle 10 to increase a horizontal dimension of the cargo area of bed 36. In the depicted embodiment, each of side walls 44, 46 include a forward wall 234 that is movable within an opening in an end wall 236 of bed 36. Each side wall 44, 46 further includes a floor portion 238 that extends inwardly from the side wall. Each floor portion 238 includes floor panels 240, 242 and wheel well panels 244, 246, 248. When side walls 44, 46 are in the retracted position of FIG. 26, forward walls 234 are positioned within end wall 236, floor panels 240, 242 are positioned over floor 48, and wheel well panels 244, 246, 248 are positioned over wheel wells 54. When side walls 44, 46 are moved to the extended position of FIG. 27, each of the above-described components moves outwardly relative to longitudinal axis X of vehicle 10 to increase the area of floor 48 of bed 36. Again, it should be understood that a plurality of different support and actuation assemblies 116 may be adapted to facilitate movement of side walls 44, 46 between the extended position and the retracted position. It should further be understood that forward walls 234 may be positioned adjacent end wall 236 (as opposed to within end wall 236) when side walls 44, 46 are in the retracted position. Similarly, floor panels 240, 242 and wheel well panels 244, 246, 248 may be positioned within recesses or openings formed in or below floor 48 and wheel wells 54 (as opposed to over those components) when side walls 44, 46 are in the retracted position.

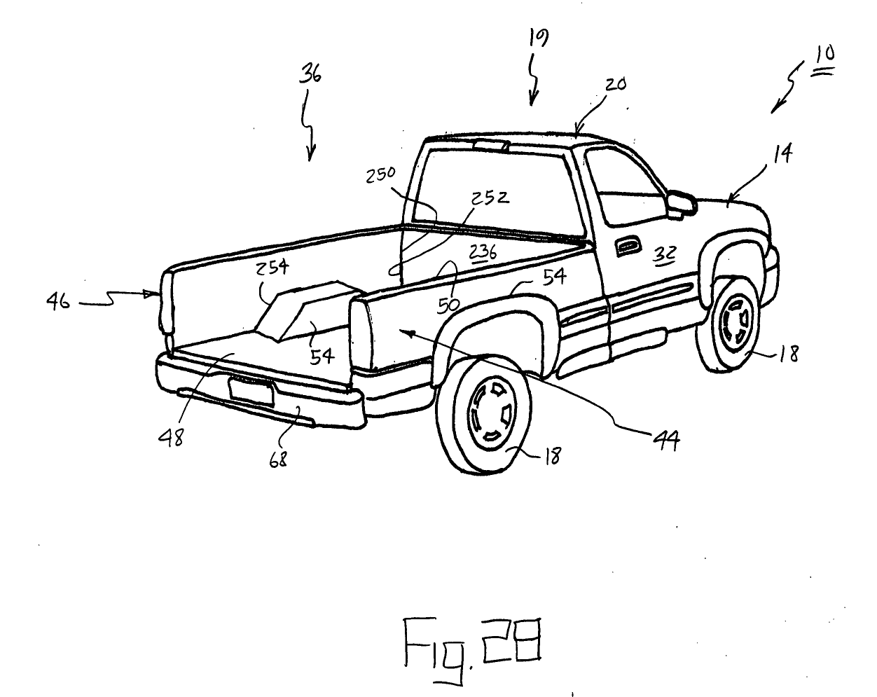

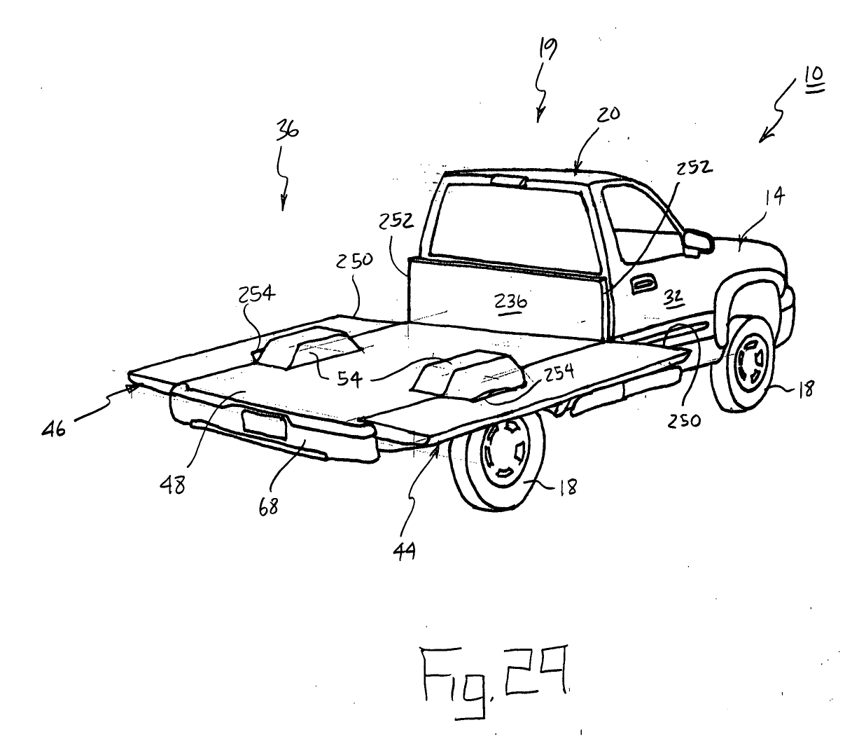

FIGS. 28 and 29 depict yet another embodiment of an apparatus for adjusting the cargo area of a vehicle. In this embodiment, side walls 44, 46 are pivotally mounted to floor 48 of bed 36. More specifically, each side wall 44, 46 includes a lower hinge (not shown) adjacent the intersection between the side wall and floor 48. Additionally, each side wall 44, 46 may include a locking mechanism (not shown) along a front edge 250 of the side wall for mating with a corresponding latch or locking mechanism (not shown) positioned along an edge 252 of end wall 236, thereby locking the side wall in a vertical orientation as shown in FIG. 28. When side walls 44, 46 are moved to the extended position shown in FIG. 29, the locking mechanisms are disengaged to permit side walls 44, 46 to pivot outwardly into a substantially planar orientation relative to floor 48 of bed 36. As can be seen in FIG. 29, each of side walls 44, 46 includes a notch 254 to accommodate wheel well 54 of bed 36 when the side wall is in the retracted position. After moving side walls 44, 46 to the extended position, the user has substantially unimpeded access to cargo stored in bed 36. For example, a forklift may be used to access pallets loaded on floor 48 not only from the tailgate end of floor 48, but also from the sides of floor 48.

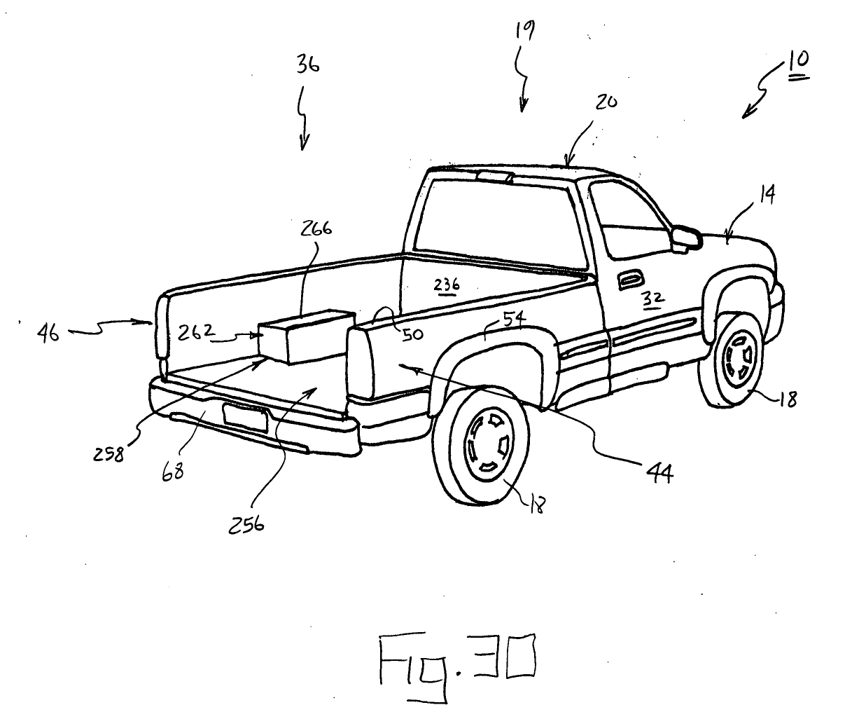

FIGS. 30-32 depict still another embodiment of an apparatus for configuring the cargo area of a vehicle. In this embodiment, bed 36 includes a movable floor portion 256, which is positioned over floor 48 of bed 36 when in the retracted position. Floor portion 256 includes a pair of notches 258, 260 configured to clear enclosures 262, 264 formed over wheel wells 54. Each of enclosures 262, 264 includes a removable top panel 266 which is configured to mate with a respective notch 258, 260 of floor portion 256 as is further described below.

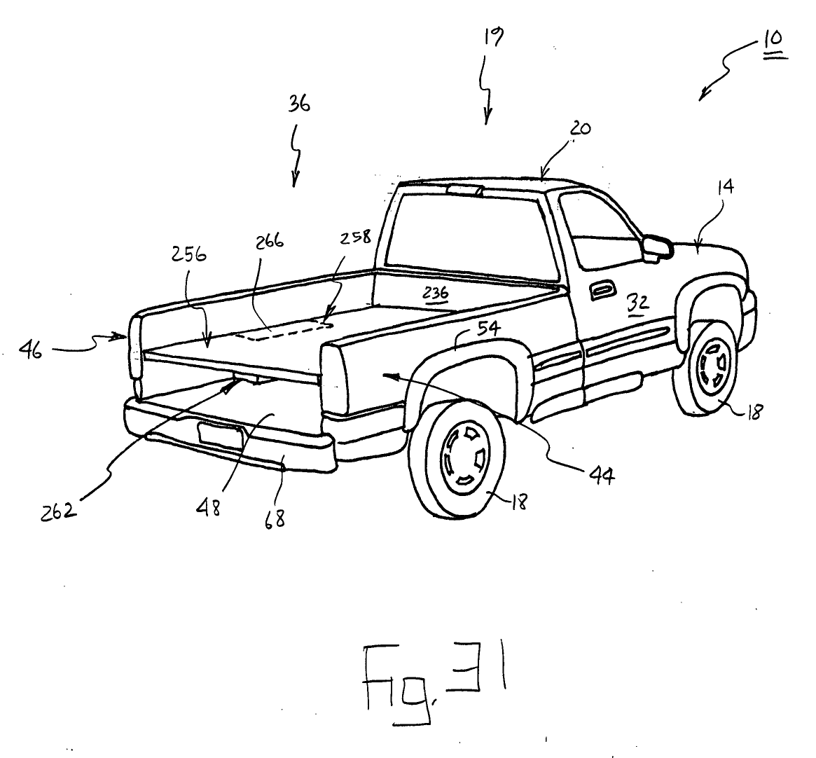

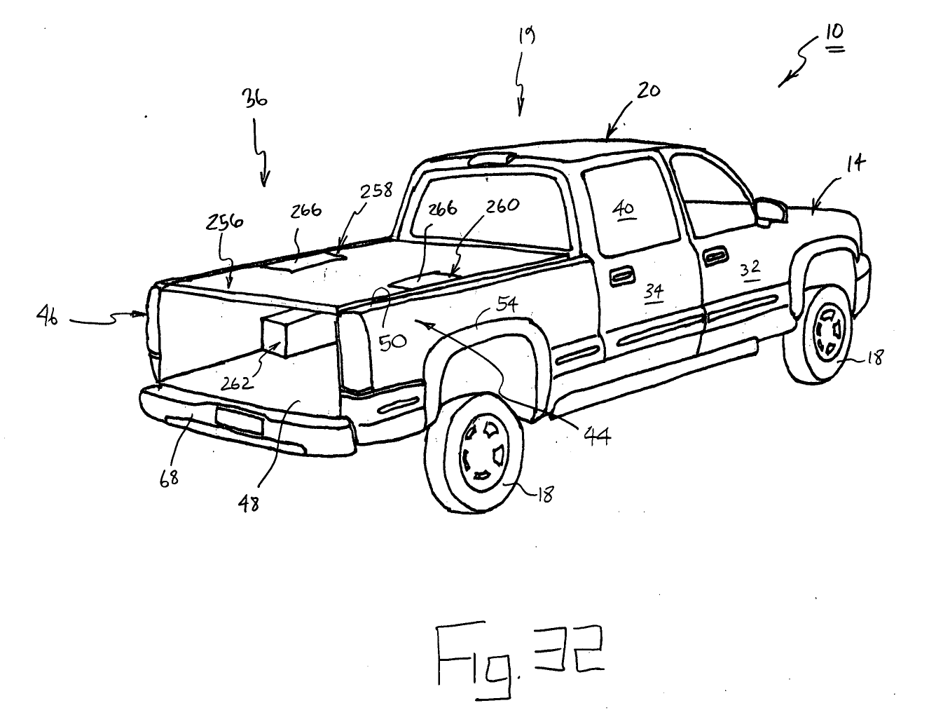

When in the retracted position of FIG. 30, floor portion 256 is positioned on floor 48 of bed 36 and top panels 266 are secured to an upper end of enclosures 262, 264. In this position, substantially the entire vertical dimension of cargo area of bed 36 is available for cargo. FIG. 31 depicts floor portion 256 in an intermediate position between the retracted position and the extended position. In this intermediate position, notches 258, 260 engage and couple to top panels 266. As floor portion 256 is moved to the fully extended position of FIG. 32, floor portion 256 and top panels 266 form a substantially continuous cover (similar to a conventional tonneau cover) for the cargo area of bed 36.

As should be understood from the foregoing, any of a variety of different support and actuation assemblies 118 may be used to move floor portion 256 between the retracted position and the extended position. In this manner, floor portion 256 may, in addition to functioning as a cover over the cargo area of bed 36 when in the extended position, function as a lift to raise cargo stored in bed 36 to permit unloading of the cargo over side wall 44, 46. More specifically, when floor portion 256 is in the extended position of FIG. 32, a forklift has substantially unimpeded access from the side of vehicle 10 to, for example, pallets loaded on floor portion 256. As should also be apparent from the drawings, movable floor portion 256 permits loading of the cargo area of bed 36 by placing cargo on floor portion 256 while floor portion 256 is in the extended position. In this manner, individuals loading bed 36 can avoid sliding cargo rearwardly from the tailgate end of bed 36 toward the forward end of bed 36 or lowering cargo into bed 36 over side walls 44, 46. Once the cargo is loaded onto floor portion 256, the user may retract floor portion 256 to the retracted position of FIG. 30. As floor portion 256 moves toward the retracted position, it moves through the intermediate position of FIG. 31 and disengages from top panels 266 as top panels 266 engage enclosures 262, 264 over wheel wells 54. This automatic decoupling may be accompanied by automatic latching of top panels 266 to their respective enclosures 262, 264.

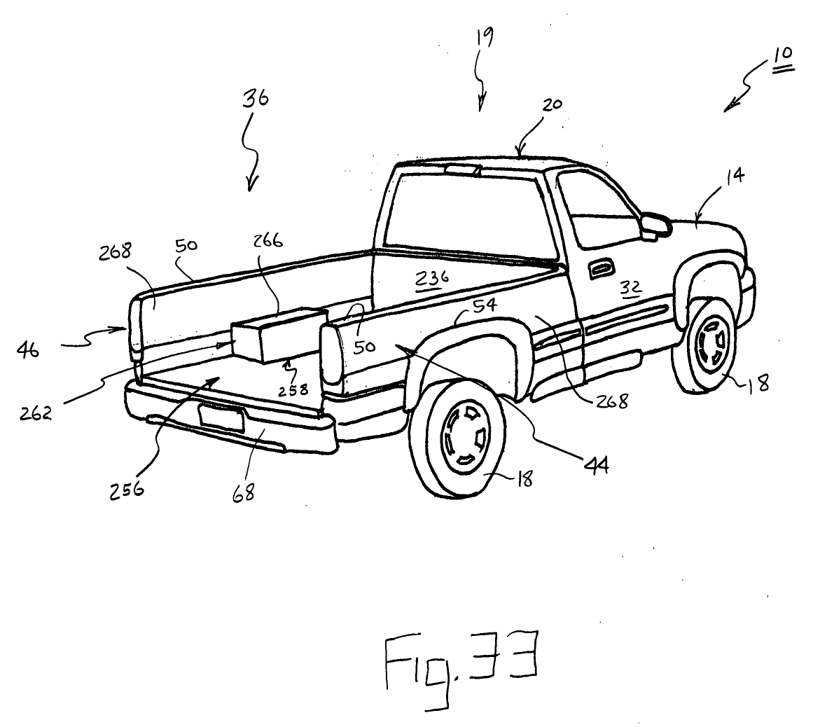

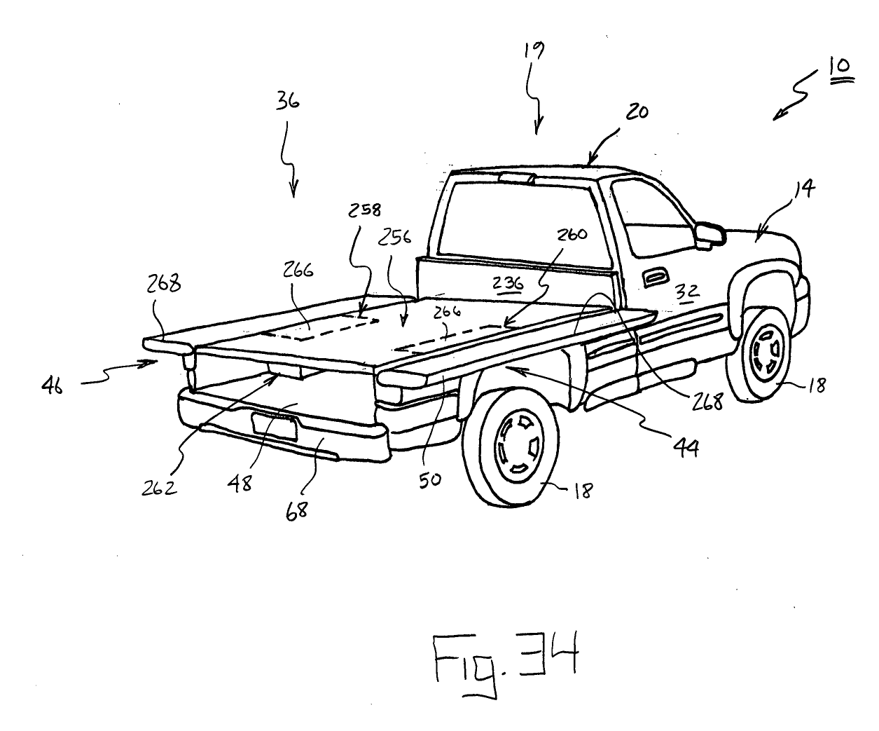

FIGS. 33 and 34 show a variation of the apparatus depicted in FIGS. 30-32. In this variation, floor portion 256 is substantially identical to floor portion 256 of the preceding figures. Side walls 44, 46, however, each include a movable upper panel 268 that may extend substantially the entire length of the respective side wall 44, 46. Panels 268 are pivotally connected to their respective side walls 44, 46 such that they are movable outwardly to the substantially horizontal orientation shown in FIG. 34. Like the embodiment shown in FIGS. 28 and 29, upper panels 268 may include latching or locking mechanisms that cooperate with corresponding mechanisms mounted to end wall 236 of bed 36 to secure upper panels 268 in the vertical orientation shown in FIG. 33.

As should be apparent from the foregoing, floor portion 256 may be moved between the retracted position and the fully extended position in the same manner as described above with reference to FIGS. 30-32 when upper panels 268 are in the vertical orientation. Additionally, floor portion 256 may be positioned in the intermediate position shown in FIG. 34, and upper panels 268 may be pivoted outwardly to their horizontal orientation, thereby forming a substantially planar raised surface over floor 48 of bed 36. The embodiment of FIGS. 33 and 34 provides the same lifting and lowering capability of the previously described embodiment as well as permitting side loading and unloading of cargo onto floor portion 256 when in the fully extended position or the intermediate position depicted in FIG. 34.

The foregoing description of the invention is illustrative only, and is not intended to limit the scope of the invention to the precise terms set forth. Although the invention has been described in detail with reference to certain illustrative embodiments, variations and modifications exist within the scope and spirit of the invention as described and defined in the following claims.

What is claimed is:

1. A vehicle, including:
a body having a cab and a bed;
a first expansion portion connected to a back end of the cab for movement toward the back end into a retracted position and away from the back end into an extended position, thereby respectively decreasing and increasing an interior space of the cab; and
a second expansion portion connected to the bed for movement toward the back end into a retracted position and away from the back end into an extended position, thereby respectively decreasing and increasing a cargo area of the bed.

2. The vehicle of claim 1, wherein the vehicle has a first length when the second expansion portion is in the retracted position and a second length, which is larger than the first length, when the second expansion portion is in the extended position.

3. The vehicle of claim 1, wherein the vehicle has a first wheel base when the first expansion portion is in the retracted position and a second wheel base, which is larger than the first wheel base, when the first expansion portion is in the extended position.

4. A vehicle, including:
a body having a cab, a bed, and a longitudinal axis; and
an expansion portion connected to a back end of the cab for movement toward the back end into a retracted position and away from the back end into an extended position, thereby respectively decreasing and increasing an interior space of the cab.

5. The vehicle of claim 4, wherein the expansion portion includes a rear wall extending substantially between a pair of side walls of the bed, and a plurality of telescopic sections that are substantially nested when the expansion portion is in the retracted position, and extended when the expansion portion is in the extended position.

6. A cargo area container adapted for mounting in a bed of a pickup truck, the container including:
a housing having a pair of side walls, an upper wall extending between the side walls, and a lower wall extending between the side walls, the side walls, upper wall, and lower wall collectively forming an interior space; and
an expandable insert having a pair of side walls, an upper wall extending between the insert side walls, a lower wall extending between the insert side walls, and a rear wall extending between the insert side walls, upper wall, and lower wall, the insert being mounted to the housing for movement between a retracted position wherein the insert is positioned substantially within the interior space, and an extended position wherein the insert extends from the housing.

7. The container of claim 6, wherein the insert moves between the extended position and the retracted position along an axis that is substantially parallel to a longitudinal axis of the truck.

8. The container of claim 6, wherein the rear wall includes a window.

9. An expandable cover for a bed of a pickup truck, including:
an upper wall configured to span between a pair of side walls of the bed; and
a plurality of side panels configured to substantially span an area between the upper wall and the upper edge when the upper wall is moved to an extended position wherein the upper wall is spaced above the upper edge, and to be positioned between the bed side walls when the upper wall is moved to a retracted position wherein the upper wall is substantially planar with the upper edge.

10. The cover of claim 9, wherein a first portion of the plurality of side panels are configured to be received by a cavity formed in one bed side wall when the upper wall is in the retracted position, and a second portion of the plurality of side panels are configured to be received by a cavity formed in the other bed side wall when the upper wall is in the retracted position.

11. The cover of claim 9, wherein adjacent side panels within the plurality of side panels interlock with one another when the upper wall is in the extended position.

13. The cover of claim 9, further including a plurality of actuation assemblies connected between the bed and the upper wall for moving the upper wall between the retracted position and the extended position.

14. The cover of claim 13, wherein each assembly includes a housing configured for mounting to a side wall of the bed, and a first segment that is telescopically movable within the housing.

15. The cover of claim 14, wherein each housing is mounted within a cavity formed in a bed side wall.

16. The cover of claim 14, wherein each assembly further includes a second segment that is telescopically movable within the first segment and connected to the upper wall.

17. The cover of claim 13, wherein each assembly includes a lower bracket adapted for mounting to a bed side wall, an upper bracket connected to the upper wall, and a pair of braces extending between the lower bracket and the upper bracket.

18. The cover of claim 17, wherein the lower bracket includes a pair of slots, the upper bracket includes a pair of slots, and each brace includes a first pin adjacent one end of the brace and a second pin adjacent another end of the brace, the first pins of the braces moving within the upper bracket slots and the second pins of the braces moving within the lower bracket slots and the upper wall moves between the retracted position and the extended position.

19. The cover of claim 17, wherein the braces of each assembly pivot relative to one another about a pivot pin extending between the braces.

20. An expandable cover for the bed of a pickup truck, including:
a first side segment configured for pivotal connection adjacent an upper edge of a first side wall of the bed;
a second side segment configured for pivotal connection adjacent an upper edge of a second side wall of the bed;
a first top segment pivotally connected to an edge of the first side segment; and
a second top segment pivotally connected to an edge of the second side segment;
wherein when the cover is in an extended position, the side segments extend upwardly from the upper edges and the top segments extend over the bed.

21. The cover of claim 20, wherein when the cover is in a retracted position, the top segments and the side segments are positioned in substantially parallel relationship to the side walls of the bed.

22. The cover of claim 21, wherein when the cover is in the retracted position, the first top segment is positioned between the first side wall and the first side segment, and the second top segment is positioned between the second side wall and the second side segment.

23. An expandable cover for the bed of a pickup truck, including:
an upper wall having a first notch and a second notch, the upper wall defining an interior space therein;
a first foldable side wall adapted for connection to a first side wall of the bed, the first foldable side wall having an upper segment and a lower segment pivotally connected to the upper segment;
a second foldable side wall adapted for connection to a second side wall of the bed, the second foldable side wall having an upper segment and a lower segment pivotally connected to the upper segment;
a first insert; and
a second insert;
wherein the upper wall is movable between a retracted position
wherein the upper wall is positioned substantially adjacent a floor of the bed, the foldable side walls are substantially enclosed within the interior space of the upper wall, and the first and second inserts extend partially through the first and second notches, respectively, and an extended position wherein the upper wall is spaced above the bed side walls, the upper segments of the foldable side walls are substantially planar with the lower segments of the foldable side walls, and the inserts may be inserted into the notches to for a substantially continuous cover over the bed.

24. A vehicle having an expandable cargo area, including:
a pair of side walls partially defining the cargo area; and
a cap extending between the side walls;
each side wall including an inner panel connected to a floor of the cargo area, and an outer panel mounted to the inner panel for vertical movement relative to the floor between a retracted position, wherein the outer panels support the cap at a first distance above the floor, and an extended position, wherein the outer panels support the cap at a second distance above the floor, the second distance being larger than the first distance.

25. The vehicle of claim 24, wherein each outer panel includes a cavity for receiving the respective inner panel when the outer panels are in the retracted position.

26. A vehicle having an expandable cargo area, including:
a pair of side walls extending along a respective two sides of a cargo area of the vehicle, the sides being substantially parallel to a longitudinal axis of the vehicle; and
an end wall extending along a third side of the cargo area, the third side being substantially perpendicular to the longitudinal axis;
wherein each side wall includes a forward wall and a floor portion and is configured for lateral movement relative to the longitudinal axis between a retracted position wherein the floor portions cover a portion of the floor of the cargo area and the side walls define a first width of the cargo area, and an extended position wherein the portion of the floor of the cargo area is revealed and the side walls define a second width that is larger than the first width.

27. A vehicle having a configurable cargo area, including
a floor defining a lower boundary of the cargo area;
a first side wall connected to the floor along one side of the cargo area; and
a second side wall connected to the floor along another side of the cargo area in substantially parallel relationship to the first side wall;
the side walls being pivotally connected to the floor for movement between a substantially vertical orientation wherein the side walls engage an end wall of the cargo area to substantially enclose three sides of the cargo area, and a substantially horizontal position wherein the side walls disengage the end wall and are substantially planar with the floor.

28. An apparatus for configuring a vehicle cargo area having a floor and a pair of side walls, the apparatus including:
a floor portion configured to be mounted in the cargo area between the side walls for movement between a retracted position wherein the floor portion is positioned substantially adjacent the cargo area floor, and an extended position wherein the floor portion is positioned above the cargo area floor;
a support and actuation assembly for moving the floor portion between the retracted position and the extended position; and
a pair of wheel well enclosures, each enclosure including a top panel;
wherein a pair of notches in the floor position couple with the enclosure top panels as the floor portion moves from the retracted position to the extended position, and disengage the top panels as the floor portion moves from the extended position to the retracted position.

29. The apparatus of claim 28, wherein the floor portion is substantially planar with an upper edge of the side walls when in the extended position.

30. A vehicle having a cargo area, the vehicle including:
a pair of side walls extending longitudinally along a floor of the cargo area in substantially parallel relationship to one another; and
a floor portion configured to be mounted in the cargo area between the side walls for movement between a retracted position wherein the floor portion is positioned substantially adjacent the cargo area floor, an intermediate position wherein the floor portion is positioned a first distance above the cargo area floor, and an extended position wherein the floor portion is positioned a second distance above the cargo area floor, the second distance being larger than the first distance;
wherein each side wall includes an upper panel having an upper edge and a lower edge that is pivotally connected to the side wall for movement between a substantially vertical orientation and a substantially horizontal orientation.
